(19) United States
(12) Patent Application Publication
(10) Pub. No.: US 2008/0195688 A1
(43) Pub. Date: Aug. 14, 2008

(54) INFORMATION PROCESSING APPARATUS, INFORMATION PROCESSING METHOD, AND COMPUTER PROGRAM PRODUCT

(76) Inventor: Hideyuki WATANABE, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/028,339

(22) Filed: Feb. 8, 2008

(30) Foreign Application Priority Data
Feb. 14, 2007 (JP) 2007-033262
Jul. 2, 2007 (JP) 2007-173939
Dec. 28, 2007 (JP) 2007-339668

(51) Int. Cl. G06F 15/16

(52) U.S. Cl. 709/201

(57) ABSTRACT

An information processing apparatus determines, upon receipt of a packet via a network while in one of a plurality of power-saving modes, whether the packet is a reply request packet not requiring a process to be performed by the information processing apparatus. When the received packet is a reply request packet not requiring a process to be performed, the information processing apparatus generates a response packet to the received packet while in the one of the power-saving modes. The information processing apparatus returns the response packet via the network to the source of the reply request packet.

### CROSS-REFERENCE TO RELATED APPLICATIONS

The present application claims priority to and incorporates by reference the entire contents of Japanese priority documents 2007-033262 filed in Japan on Feb. 14, 2007, 2007-173939 filed in Japan on Jul. 2, 2007 and 2007-339668 filed in Japan on Dec. 28, 2007.

### BACKGROUND OF THE INVENTION

1. Field of the Invention

The present invention relates to an information processing apparatus, an information processing method, and a computer program product.

2. Description of the Related Art

For example, Japanese Patent Application Laid-Open Publication No. 2001-328313 discloses a conventional information processing apparatus that enters energy-saving mode (power-saving mode) in a waiting state. The conventional image forming apparatus includes a printer controller that converts print information transmitted from a printer or host into output image data to output the data to the printer, a power source device for supplying electric power to the printer and the printer controller, and a unit that switches a mode of power supply from the power source device to the load of the printer between an energy-saving mode and an operation mode.

As another example, Japanese Patent Application Laid-Open Publication No. 2005-041214 discloses a conventional information processing apparatus that immediately recovers from energy-saving mode when receiving a broadcast packet such as an address resolution protocol (ARP) packet or a certain pattern during the energy-saving mode. The conventional information processing apparatus also recovers from energy-saving mode upon receiving a packet Internet groper (PING) packet to respond thereto with a PING response.

PING is a program that sends an Internet control message protocol (ICMP) echo request packet to a target apparatus of investigation through the ICMP to diagnose a network based on data such as presence of response and response time from the apparatus.

However, in the former conventional information processing apparatus, when responding to a packet received from a network, it is required that the power consumption mode be canceled and the normal operation mode be restored. Therefore, the power-saving effect is low.

In the latter conventional information processing apparatus, when responding to a packet due to a PING received from a network, since the power-saving mode is canceled and the normal operation mode is restored to use a central processing unit (CPU) and a memory consuming a lot of power to execute the response to the PING, which is relatively a simple process, it is problematic that the power-saving effect is low.

### SUMMARY OF THE INVENTION

It is an object of the present invention to at least partially solve the problems in the conventional technology.

According to an aspect of the present invention, there is provided an information processing apparatus that includes a controlling unit that controls a plurality of power-saving modes; a determining unit that determines, upon receipt of a packet via a network while the information processing apparatus is in one of the power-saving modes, whether received packet is a reply request packet that does not require a process to be performed; and a generating unit that generates, when the received packet is a reply request packet that does not require a process to be performed, a response packet to the received packet while maintaining the information processing apparatus in the one of the power-saving mode. The determining unit determines, based on content of the received packet, whether the received packet requests return of predetermined information. The generating unit generates, when the received packet requests return of predetermined information, the response packet including the predetermined information.

According to another aspect of the present invention, there is provided an information processing method applied to an information processing apparatus having a plurality of power-saving modes. The information processing method includes controlling the power-saving modes; determining, upon receipt of a packet via a network while the information processing apparatus is in one of the power-saving modes, whether received packet is a reply request packet that does not require a process to be performed; and generating, when the received packet is a reply request packet that does not require a process to be performed, a response packet to the received packet while maintaining the information processing apparatus in the one of the power-saving mode. The determining includes determining, based on content of the received packet, whether the received packet requests return of predetermined information. The generating includes generating, when the received packet requests return of predetermined information, the response packet including the predetermined information.

According to still another aspect of the present invention, there is provided a computer program product that implements the above method on a computer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional block diagram of an information processing apparatus according to a first embodiment of the present invention;

FIG. 2 is a schematic diagram for explaining the shift from one mode to another related to power supply in the information processing apparatus shown in FIG. 1;

FIG. 3 is a schematic diagram of a frame format of an Ethernet packet;

FIG. 4 is a table of an example of data contents of fields in an Ethernet frame;

FIG. 5 is a schematic diagram for explaining a correlation between frames of an ARP packet and the Ethernet packet;

FIG. 6 is a schematic diagram of a format of the ARP packet;

FIG. 7 is a table of an example of data contents of fields in the ARP packet;

FIG. 8 is a schematic diagram of a format of an IP packet;

FIG. 9 is a table of an example of data contents of fields of the IP header in the IP packet;

FIG. 10 is a schematic diagram for explaining a correlation between frames of the IP packet and a TCP packet and the Ethernet packet;

FIG. 11 is a schematic diagram of a format of the TCP packet;

FIG. 12 is a schematic diagram of a format of a UDP packet;

FIG. 13 is a block diagram of a PF shown in FIG. 1;

FIG. 14 is a schematic diagram for explaining an internal operation of a PE shown in FIG. 1;

FIG. 15 is a schematic diagram of an example of the TCP packet allowed to pass through in the filtering process of the PF shown in FIG. 1;

FIG. 16 is a schematic diagram of an example of the UDP packet allowed to pass through in the filtering process of the PF shown in FIG. 1;

FIG. 17 is a schematic diagram of an example of the ARP packet allowed to pass through in the filtering process of the PF shown in FIG. 1;

FIG. 18 is a functional block diagram of an information processing apparatus according to a second embodiment of the present invention;

FIG. 19 is a schematic diagram of formats of the IP packet and the ICMP packet in the Ethernet frame;

FIG. 20 is a schematic diagram of a format of an ICMP echo request packet and an ICMP echo reply packet;

FIG. 21 is a block diagram of a PF shown in FIG. 18;

FIG. 22 is a schematic diagram of an example of the TCP packet allowed to pass through in the filtering process of the PF shown in FIG. 18;

FIG. 23 is a schematic diagram of an example of the UDP packet allowed to pass through in the filtering process of the PF shown in FIG. 18;

FIG. 24 is a schematic diagram for explaining an internal operation of a PE shown in FIG. 18 for filtering the ICMP packet;

FIG. 25 is a schematic diagram of an example of the ICMP packet allowed to pass through in the filtering process of the PF shown in FIG. 18;

FIG. 26 is a functional block diagram of an information processing apparatus according to a third embodiment of the present invention;

FIG. 27 is a schematic diagram of an example of a packet allowed to pass through in the filtering process of a PF shown in FIG. 26;

FIG. 28 is a block diagram of a PE shown in FIG. 26;

FIG. 29A is a schematic diagram of the MIB request packet when a request ID length is one;

FIG. 29B is a schematic diagram of the MIB request packet when a request ID length is two;

FIG. 29C is a schematic diagram of the MIB request packet when a request ID length is three;

FIG. 29D is a schematic diagram of the MIB request packet when a request ID length is four;

FIG. 30 is a schematic diagram for explaining the operation of an MIB response packet generating unit shown in FIG. 28; and

FIG. 31 is a schematic diagram of an IP packet of the MIB response.

### DETAILED DESCRIPTION OF THE PREFERRED EMBODIMENTS

Exemplary embodiments of the present invention are described in detail below with reference to the accompanying drawings.

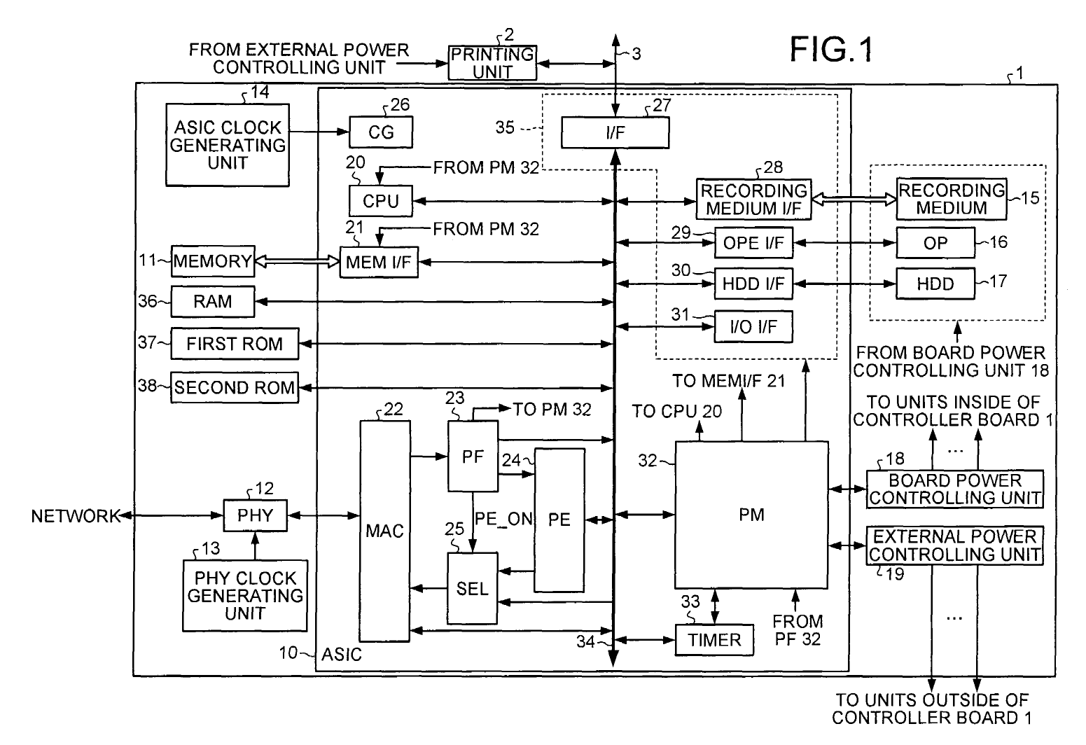

FIG. 1 is a functional block diagram of an information processing apparatus according to a first embodiment of the present invention. The information processing apparatus is explained below as a printer, and includes a controller board 1 for the control of thereof and a printing unit 2.

The controller board 1 includes an application specific integrated circuit (ASIC) 10, a memory 11 including a double-data-rate synchronous dynamic random access memory (DDR-SDRAM), a network physical layer (PHY) 12 transmitting/receiving various data (packets) to/from a network, a PHY clock generating unit 13, an ASIC clock generating unit 14, a recording medium 15, an operating unit such as an operation panel (OP) 16, a hard disc device (HDD) 17, a board power controlling unit 18, an external power controlling unit 19, a nonvolatile memory (RAM) 36, a first ROM 37 having computer programs and data stored thereon, and a second ROM 38 having a media access control (MAC) address stored thereon. As the recording medium 15, various media can be used including memory cards (registered trademark) and secure digital (SD) cards (registered trademark).

The first ROM 37 has two computer programs and data stored thereon. The two computer programs includes a first program running at the time of power-on and a second program activated from the first program. At the time of power-on, a CPU 20 executes the first program on the first ROM 37 to load the second program into the memory 11. The second program loaded into the memory 11 is executed after the first program is executed.

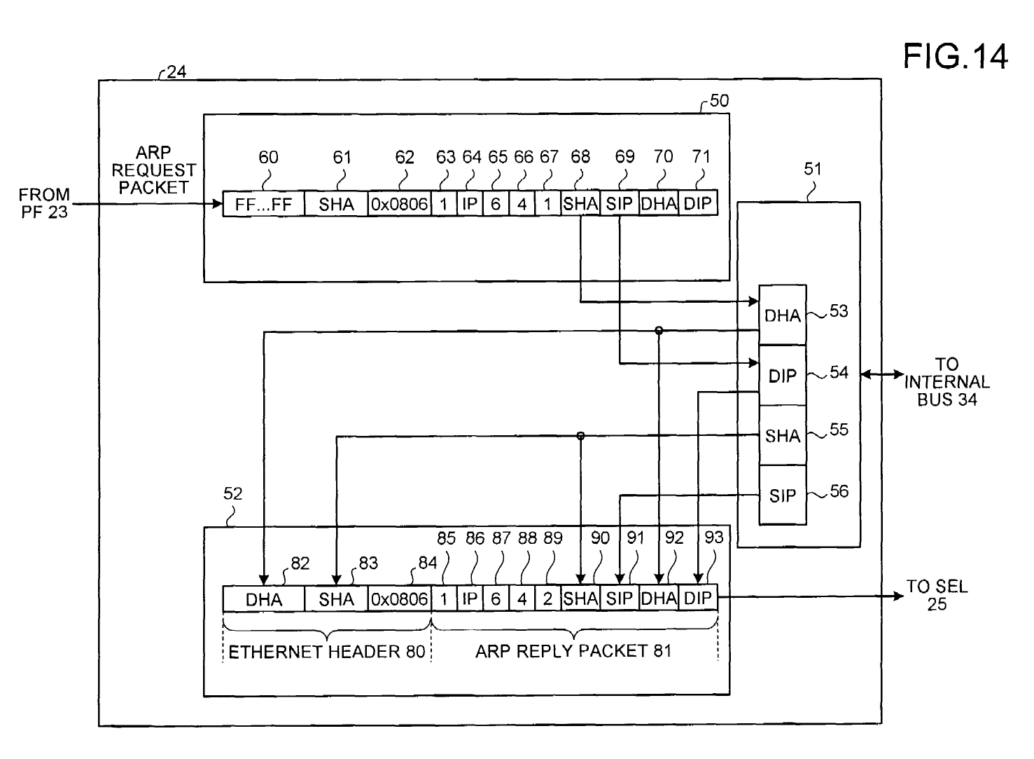

After the second program is activated, the CPU 20 stores the MAC address stored in the second ROM 38 into a request source hardware address (SHA) (shown in FIG. 14 and described later) in a register unit (shown in FIG. 14 and described later) of a PE 24.

The RAM 36 stores therein the Internet Protocol (IP) address of the printer and can change the IP address in response to a request from an OS 16. The CPU 20 stores the changed IP address in the RAM 36. Since the RAM 36 is a nonvolatile memory, the contents can be retained even when the power is turned off. The CPU 20 stores the IP address on the RAM 36 at a request source IP address in the register unit of the PE 24.

The ASIC 10 includes the CPU 20 that is a main controlling unit, a memory interface unit (hereinafter, “MEMI/F”) 21 for exchanging data with the memory 11, a MAC 22 that communicates with the PHY 12, a packet filter (PF) 23 that receives packets output from the MAC 22 to screen the types of the packets, a network packet engine processing unit (hereinafter, “PE”) 24 that processes the packets output from the PF 23, and a selector (SEL) 25 that receives the data processed by the PE 24 and data from an internal bus 34 to send one of these data to the MAC 22.

The ASIC 10 also includes a computer graphics (CG) 26, a data transfer interface (I/F) unit (hereinafter. “I/F”) 27 including a PCI interface (I/F), a recording medium interface unit (hereinafter, “memory card I/F unit”) recording medium interface (I/F) unit (hereinafter, “recording medium I/F”) 28 that reads/writes data from/to the recording medium 15, an operation panel interface unit (hereinafter, “OPEI/F”) 29 that controls input/output through the OP 16, a hard disk drive interface unit (hereinafter, “HDDI/F”) 30 that controls reading/writing of data from/to the HDD 17, and a general-purpose input/output interface unit (hereinafter, “I/OI/F”) 31. The recording medium I/F 28 is, for example, a memory card I/F unit when the recording medium is a memory card.

The ASIC 10 also includes a power management unit (hereinafter, “PM”) 32 that controls power supply from a power source (not shown) to the units on the inside and outside of the controller board 1, and a timer 33.

The ASIC 10 has a power-off area 35 that can control power supply from the power source with the PM 32 and a constantly power-supplied area other than the power-off area 35.

The power-off area 35 includes the I/F 27, the recording medium I/F 28, the OPEI/F 29, the HDDI/F 30, and the I/OI/F 31, i.e., the units not directly related to the network operations.

The controller board 1 is connected to a printing unit (plotter) 2 through a bus 3 and connected to the internal bus 34 via the I/F 27 of the ASIC 10.

After the printer is turned on, the PM 32 of the ASIC 10 selects one of three modes, which are a normal operation mode related to the power supply described later and different types of a power-saving mode, i.e., an energy-saving mode (also called “low-power-consumption mode”) and a controller mode. The PM 32 then controls the power supply and stoppage thereof to the CPU 20, the power supply and stoppage thereof to the units in the power-off area 35 within the ASIC 10, the board power controlling unit 18, and the external power controlling unit 19.

The PM 32 notifies the MEMI/F 21 of a shift to any one of the three modes to control the power consumption of the memory 11 through the MEMI/F 21. The PM 32 may include a function of shifting the CPU 20 to a suspend mode consuming less power to notify the CPU 20 of entering into the suspend mode or to cancel the suspend mode.

Although the printer is described in the first embodiment that has two types of mode, i.e., energy-saving mode and controller mode as power-saving mode, if other types of modes can be implemented, the following process is executable for such modes.

In the control of power consumption of the memory 11, when shifting to the energy-saving mode, the PM 32 shifts the memory 11 to a self-refresh mode through the MEMI/F 21, and the memory 11 saves information of the state before shifting to the energy-saving mode and shifts to the energy-saving mode.

When shifting to the normal operation mode or the controller mode, the PM 32 shifts the memory 11 to the normal operation mode through the MEMI/F 21, and the memory 11 becomes accessible through the internal bus 34. When the memory 11 returns from the energy-saving mode to the normal operation mode, the information of the state before shifting to the energy-saving mode is recovered.

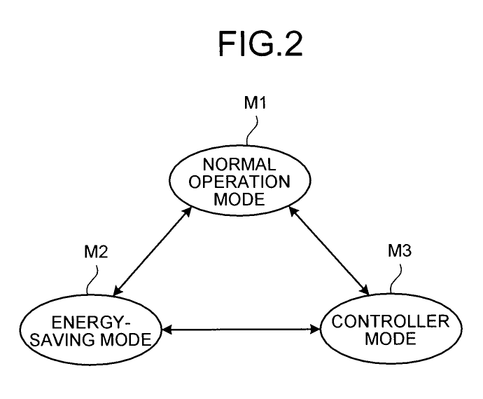

FIG. 2 is a schematic diagram for explaining the shift from one mode to another related to power supply in the printer shown in FIG. 1.

The modes related to power supply in this printer include a normal operation mode M1 supplying power to the entire printer and power consumption modes supplying a portion of the printer and stopping power supply to other units to reduce the power consumption, which are an energy-saving mode M2 and a controller mode M3.

First, when a power button (not shown) of this printer is turned on, the power source supplies power to the ASIC 10 and the PM 32 sets the normal operation mode M1. In the case of the normal operation mode M1, the PM 32 supplies power from the power source to the CPU 20 and the memory 11 as usual. The power supply is started to the units (the I/F 27, the recording medium I/F 28, the OPEI/F 29, the HDDI/F 30, and the I/OI/F 31) in the power-off area 35 and the power is also supplied to the units on the inside and outside of the controller board through the board power controlling unit 18 and the external power controlling unit 19. The ASIC 10 then starts the control of the entire printer.

When entering into the normal operation mode M1, the PM 32 activates the timer 33, and when a predetermined time set in advance has elapsed on the timer 33 from the setting of the normal operation mode M1, if no packet to the printer (own station) is received from a network and all the applications running on the CPU 20 enter into the idle state, the PF 23 shifts to the energy-saving mode M2.

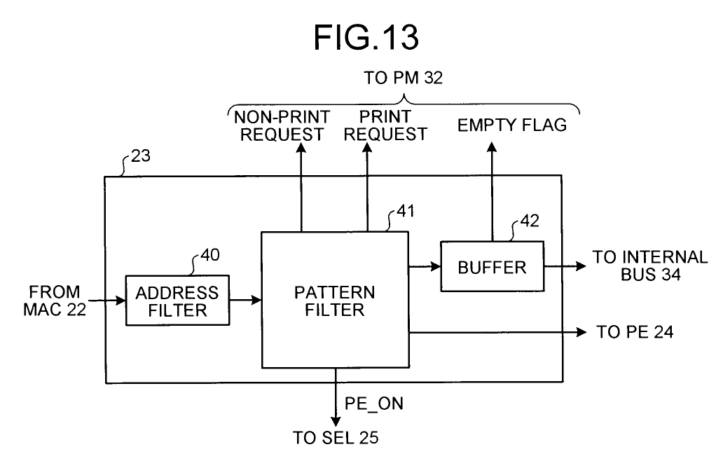

An empty flag from a buffer (shown in FIG. 13 and described later) of the PF 23 can be used to recognize that no packet to the printer (own station) is received.

During the state of the controller mode M3, the shift to the energy-saving mode M2 is performed in the same way.

When shifting the power consumption mode to the energy-saving mode, the PM 32 sets the CPU 20 and the memory 11 to the low-power-consumption mode. The power supply to the units in the power-off area 35 within the ASIC 10 is stopped; the board power controlling unit 18 stops the power supply from the power source to the recording medium 15, the OP 16, and the HDD 17; and the external power controlling unit 19 stops the power supply from the power source to the units (not shown except the printing unit 2) including the printing unit 2 on the outside of the controller board 1. The PHY 12 and the PHY clock generating unit 13 are constantly supplied with the power after the printer is powered on.

When the MAC 22 receives a packet through the PHY 12 from the network, the MAC 22 outputs the packet to the PF 23, and the PF 23 checks the contents of the packet and discards the packet if the packet is not addressed to the own printer (own station), or sends the packet addressed to the own station to the PE 24 if the packet should be processed by the PE 24.

The packets to be processed by the PE 24 include an address resolution protocol (ARP) request of the IP packet, for example.

When receiving the ARP request, the PE 24 generates a packet of an ARP response based on the contents of the ARP request and transfers the ARP response packet through the SEL 25 and the MAC 22 to the network from the PHY 12.

The packets to be processed by the PE 24 also include a “Ping command”, which is a packet arrival confirmation command transmitted from the host. When the Ping command is received from the host, a reply is sent to the host for acknowledgement of reception.

During the energy-saving mode, if a packet received from the network is a non-print-request packet, the PF 23 notifies the PM 32 and the PM 32 sets the power consumption mode to the controller mode to shift the energy-saving mode to the controller mode. When the power consumption mode is the controller mode, the PM 32 sets the CPU 20 and the memory 11 to the normal mode. The power supply from the power source to the units in the power-off area 35 within the ASIC 10 is stopped; the board power controlling unit 18 stops the power supply from the power source to the recording medium 15, the OP 16, and the HDD 17; and the external power controlling unit 19 stops the power supply from the power source to the units including the printing unit 2.

The non-print-request packets include HyperText Transfer Protocol (HTTP) packet, Simple Network Management Protocol (SNMP) packet, etc. The SNMP utilizes User Datagram Protocol (UDP).

Details of the SNMP are described in specifications of standard protocols defined by the IETF (Internet Engineering Task Force) including Request For Comments (RFC)1155, RFC1157, and RFC1213.

The management information block (MIB) information defined by RFC1213 is information published to let the outside know the state of the own apparatus and can be acquired with the use of the SNMP from the outside. The device information (MIB information) of the printer is set in the memory 11.

If the MIB information is updated before from the normal operation mode to the controller mode or the energy-saving mode, the MIB information at the normal time becomes accessible at the time of the controller mode.

During the energy-saving mode or the controller mode, if a packet received from the network is a print-request packet, the PF 23 notifies the PM 32 and the PM 32 performs control such that the energy-saving mode or the controller mode is shifted to the normal operation mode.

The print-request packets include, for example, Line Printer Daemon (LPD) (Transmission Control Protocol (TCP) Port 515), File Transfer Protocol (FTP) (TCP Port 21), and Hewlett-Packard (HP) network printer compatible protocol (TCP Port 9100) (registered trademark).

If the non-print-request packet is received during the normal operation mode, the mode is not shifted to the controller mode.

Described below is types of packets received by the printer from the network.

### 1. Ethernet Packet

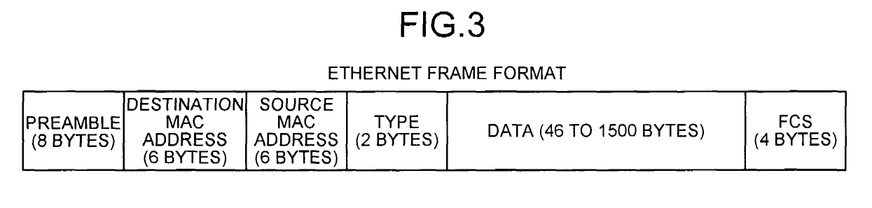

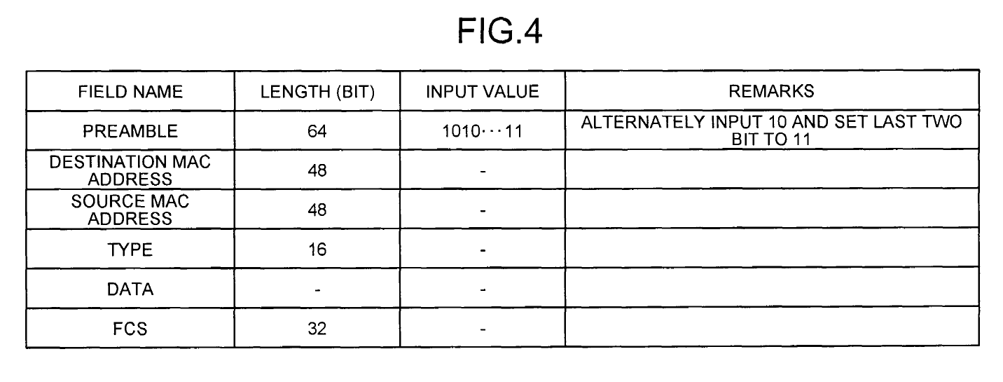

FIG. 3 is a schematic diagram of a frame format of an Ethernet packet. FIG. 4 is a table of an example of data contents of fields in an Ethernet frame.

The Ethernet packet contains a preamble, a destination MAC address, a source MAC address, a type, data, and an FCS.

As shown in FIG. 4, the preamble is information with a data length of 64 bits (8 bytes) indicating the start of frame and “0 and 1” are alternately input except the last two bits, which are “11”.

The destination MAC address and the source MAC address are an address of an apparatus that is a destination of the packet (e.g., communication device including the printer) and an address of an apparatus that is a sender of the packet, respectively, and the both have a data length of 48 bits (6 bytes). The MAC is defined by IEEE802-1990.

The destination MAC addresses include a unicast address that identifies individual communication devices in the network, a broadcast address directed to all the communication devices in a broadcast domain in the network, and a multicast address directed to the communication devices within a predetermined communication device group in the network.

In the case of the broadcast address, all bits are one. The type indicates the Ipv4 protocol in the case of 0x0800, the ARP protocol in the case of 0x0806, the Ipv6 protocol in the case of 0x86DD, the AppleTalk protocol in the case of 0x809B, the IPX (NetWare) protocol in the case of 0x8037, and the NetBIOS/NetBEUI protocol in the case of 0x8191 (registered trademark).

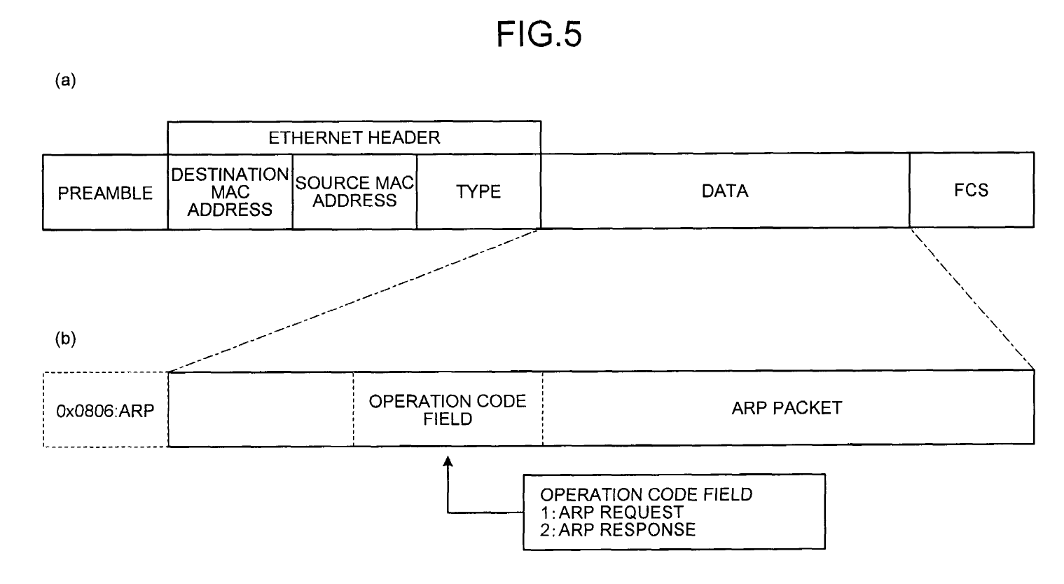

FIG. 5 depicts a correlation between frames when creating an ARP packet from the Ethernet packet. As shown (a) of in FIG. 5, the Ethernet packet contains the preamble, the destination MAC address, the source MAC address, the type, the data, and the FCS, and the destination MAC address, the source MAC address, and the type make up an Ethernet header. The data can be specified in 46 to 1500 byte length, and the FCS is a checksum and is generated by the CRC-32 polynomial.

As shown (b) of in FIG. 5, when the ARP packet is created from the Ethernet packet, the data of the Ethernet packet are included in the ARP packet; if one is stored in an operation code field in the ARP packet, this indicates an ARP request packet; and if two is stored, this indicates an ARP response packet. Data indicating the ARP protocol, i.e., 0x0806 is the protocol type of Ethernet header as shown by a dashed line (a) of in FIG. 5.

### 2. ARP Packet

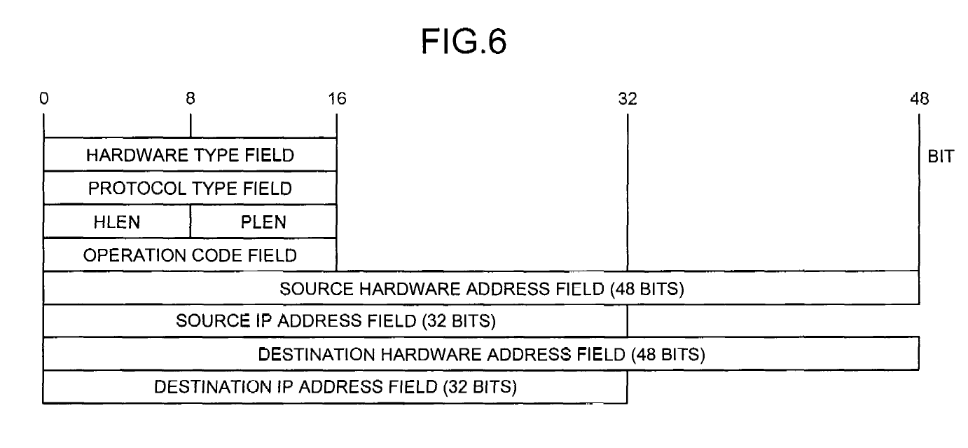

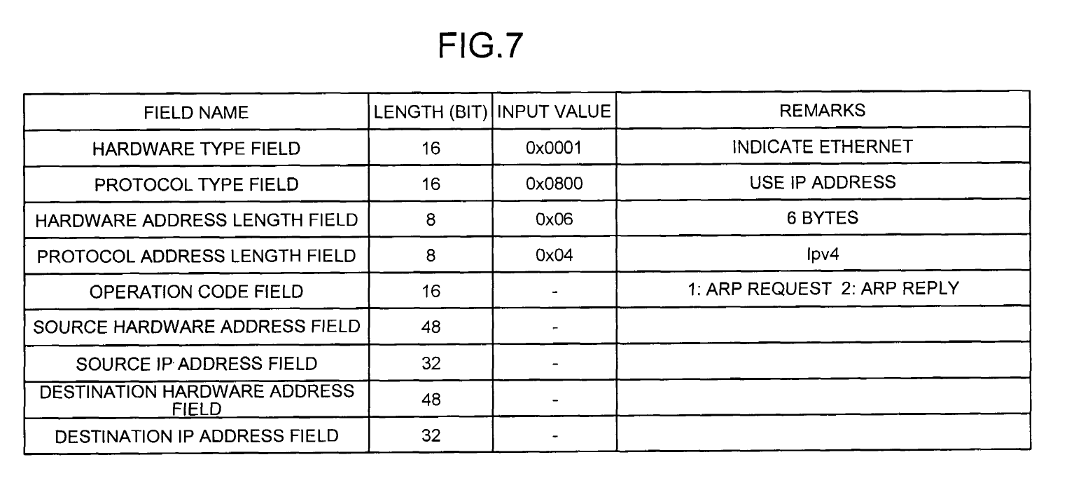

In the following description, the term “IP” refers to IPv4. FIG. 6 is a schematic diagram of a format of the ARP packet and FIG. 7 is a schematic diagram of an example of data contents of the fields in the ARP packet.

As shown in FIG. 6, the ARP packet contains a hardware type field, a protocol type field, a hardware address length (HLEN) field, a protocol address length (PLEN) field, an operation code field, a source hardware address field, a source IP address field, a destination hardware address field, and a destination IP address field.

As shown in FIG. 7, the hardware type field has a data length of 16 bits and stores 0x0001 when indicating the Ethernet packet. The protocol type field has a data length of 16 bits, uses an IP address, and stores 0x0800 when indicating the IPv4 protocol.

The hardware address length field has a data length of 8 bits and stores 6-byte data indicating a MAC address. For example, the data are 0x06. The protocol address length field has a data length of 8 bits and stores 0x04 when indicating the IPv4 protocol.

The operation code field has a data length of 16 bits, indicates the ARP request in the case of one, and indicates the ARP reply in the case of two. The source hardware address field, the source IP address field, the destination hardware address field, and the destination IP address field have data lengths of 48, 32, 48, and 32 bits, respectively, and store a source hardware address, a source IP address, a destination hardware address, and a destination IP address, respectively.

### 3. IP Packet

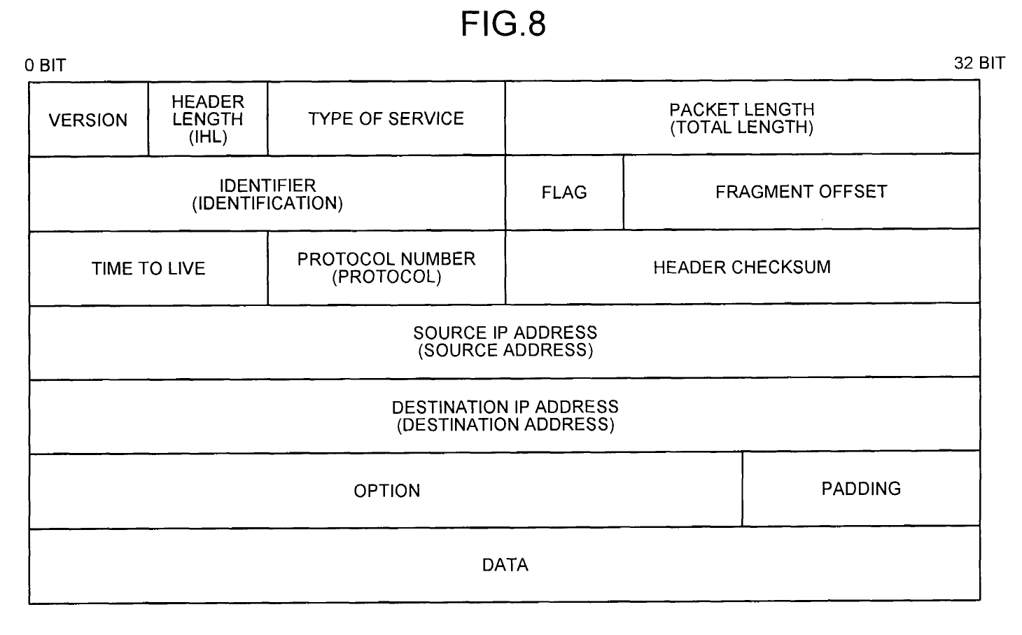

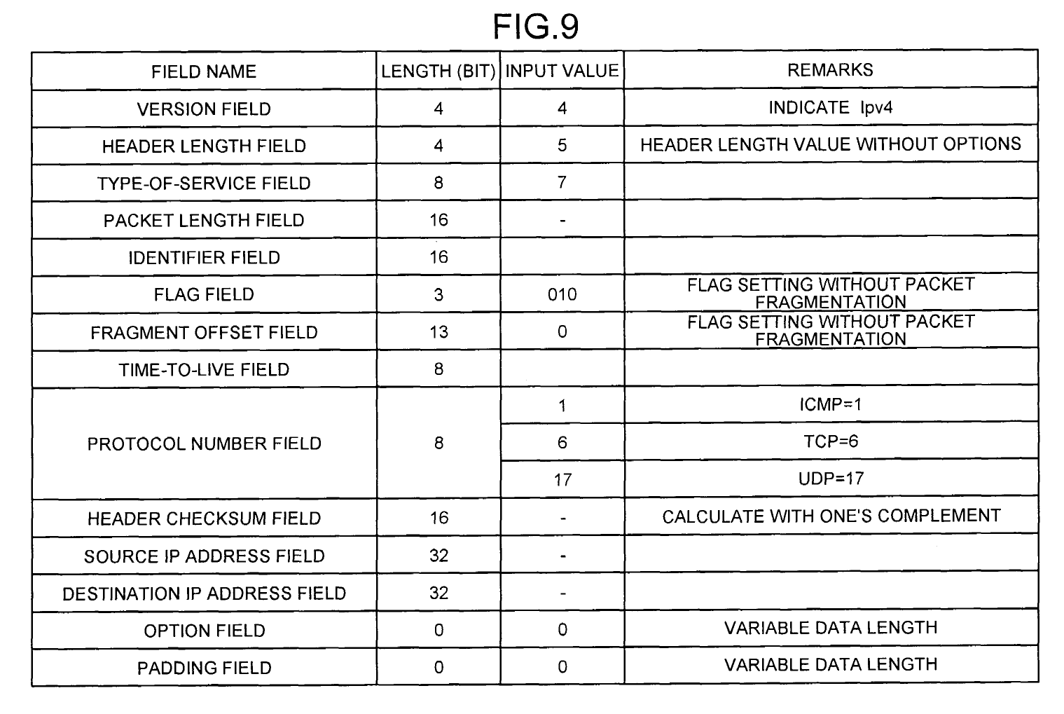

FIG. 8 is a schematic diagram of a format of an IP packet and FIG. 9 is a schematic diagram of an example of data contents of fields of the IP header in the IP packet.

As shown in FIG. 8, the IP packet contains a header portion (IP header) and a data portion, and the header portion contains a version field, a header length (IHL) field, a type-of-service field, a packet length (total length) field, an identifier (identification) field, a flag field, a fragment offset field, a time-to-live field, a protocol number (protocol) field, a header checksum field, a source IP address field, and a destination IP address field.

Options are also added in some cases and padding is performed such that a field data length including the options and the padding becomes a multiple number of 32 bits. Normally, the options are not used.

FIG. 9 depicts the data lengths of the fields, examples of values, and remarks. Particularly, the version field has a data length of 4 bits and stores four and six in the case of the IPv4 protocol and the IPv6 protocol, respectively. The header length field has a data length of 4 bits and is 20 bytes in the case of the IPv4 protocol.

The time-to-live filed stores a value of time-to-live of a packet on the network; the value is decremented by one each time the packet passes through a router; and the packet is discarded if the value becomes zero. The details thereof are described in RFC2200.

The type-of-service and the protocol number are described in RFC791 and RFC1700, respectively.

A value stored in the identifier field is used as an identifier when restoring fragments. The flag field stores a value indicating control related to packet fragmentation.

### 4. TCP Packet

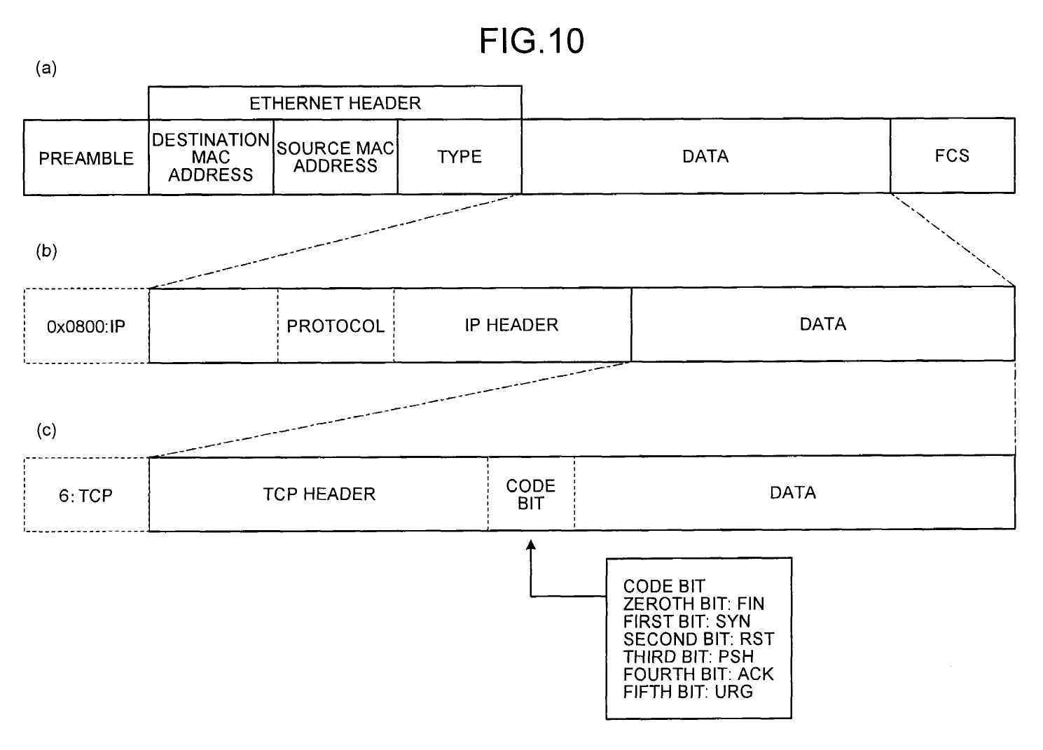

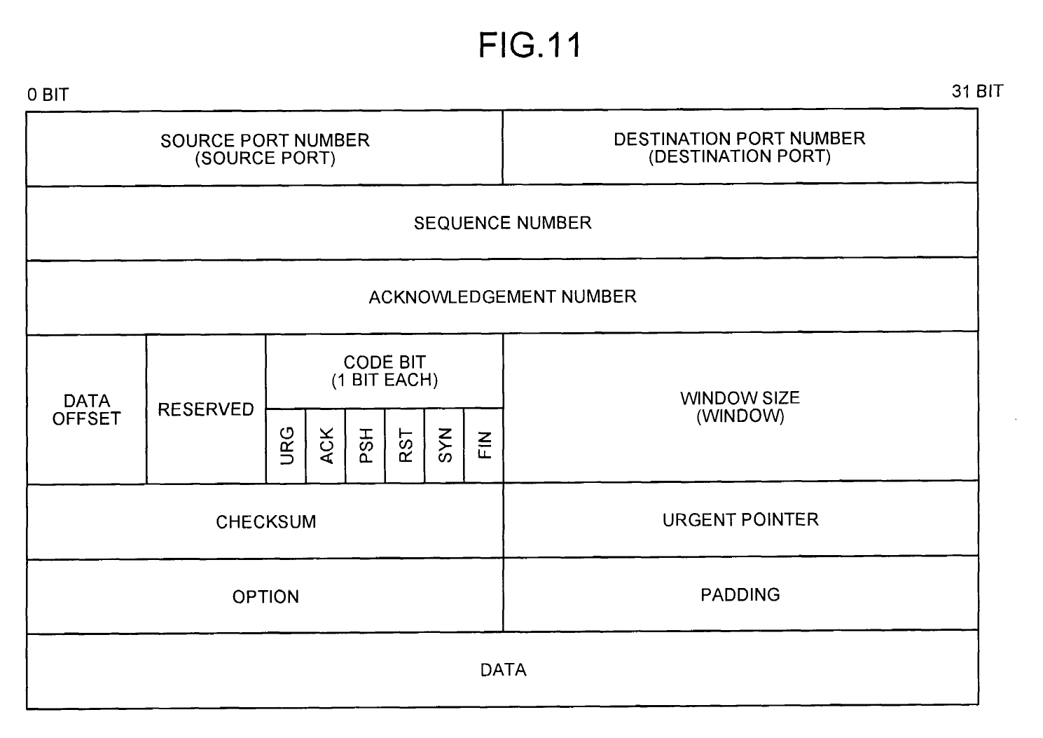

FIG. 10 depicts a correlation between frames when creating the IP packet and a TCP packet from the Ethernet packet. FIG. 11 is a schematic diagram of a format of the TCP packet.

As shown in (a) of FIG. 10, the Ethernet packet contains the preamble, the destination MAC address, the source MAC address, the type, the data, and the FCS, and the destination MAC address, the source MAC address, and the type make up the Ethernet header. The data can be specified in 46 to 1500 byte length, and the FCS is a checksum and is generated by the CRC-32 polynomial.

As shown in (b) of FIG. 10, when the IP packet is created from the Ethernet packet, the IP header and the data of the Ethernet packet are included in the IP packet. Data indicating the IP protocol, i.e., 0x0800 is the protocol type of Ethernet header as shown by a dashed line in (b) of FIG. 10.

As shown in (c) of FIG. 10, when the TCP packet is created from the IP packet, the TCP header and the data of the IP packet are included in the TCP packet. The TCP header includes code bits, which are FIN at a zeroth bit, SYN at a first bit, RST at a second bit, PSH at a third bit, ACK at a fourth bit, and URG at a fifth bit. Data indicating the TCP protocol, i.e., 6 is the protocol number filed as shown by a dashed line in (c) of FIG. 10.

As shown in FIG. 11, the TCP packet includes a TCP header portion (TCP header) and a data portion, and contains a source port number (source port, 16 bits) field, a destination port number (destination port, 16 bits) field, a sequence number (sequence number, 32 bits) field, an acknowledgement number (acknowledgement number, 32 bits) field, a data offset (data offset, 4 bits) field, a reserved (reserved, 6 bits) field, a code bit (6 bits) field, a window size (16 bits) field, a checksum (checksum, 16 bits) field, and an urgent pointer (urgent pointer, 16 bits) field.

Options and padding may exist in some cases, followed by data. Port numbers, i.e., source and destination port numbers stored in the source and destination port number fields are used for identification of application. A number standardized as a well-known port number exists (published in RFC1700). Details of TCP are described in RFC793.

### 5. UDP Packet

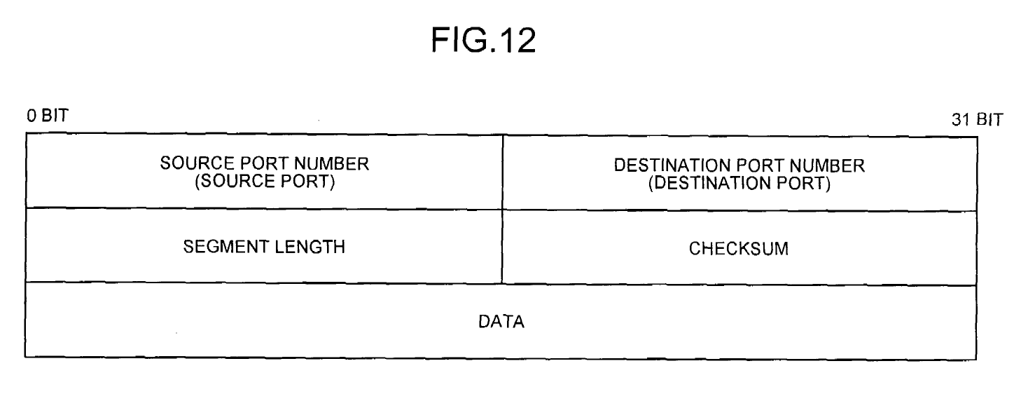

FIG. 12 is a schematic diagram of a format of a UDP packet.

The UDP packet contains a source port number (16 bits) field, a destination port number (16 bits) field, a segment length (16 bits) field, a checksum (16 bits) field, and data.

Port numbers, i.e., source and destination port numbers stored in the source and destination port number fields are used for identification of application. A number standardized as a well-known port number exists (published in RFC1700). Details of UDP are described in RFC768.

FIG. 13 is a block diagram of the PF 23. The PF 23 includes an address filter 40, a pattern filter 41, and the buffer 42.

To the address filter 40, a unicast address and a multicast address can be registered. Addresses of devices including the printing unit 2 accessible in the printer can also be set.

The address filter 40 screens packets by referring to types of packets input from the MAC 22, determining kinds of packets from the types, allowing passage of only packets for accessible devices, sending the packets to the pattern filter 41, and discarding other packets. Broadcast packets are allowed to pass and sent to the pattern filter 41 regardless of the setting of the address filter 40.

The pattern filter 41 includes a mask area and a non-mask area. The mask area has identical conditions regardless of values of the packets. In the non-mask area, comparison data can be set on the byte-to-byte basis. The mask area can be set on the byte-to-byte basis.

A sum of data lengths of the mask area and the non-mask area is a pattern filter length. For example, a pattern filter length is 64 bytes. In the pattern filter 41, a value of a first pattern offset can be set. The first pattern offset is an offset length from the start of the Ethernet frame.

If the filtering with the pattern filter 41 is started from the type of the Ethernet frame, a length of the first pattern offset is a value obtained by adding the destination MAC address length and the source MAC address.

A second pattern offset indicates an offset from the start of the pattern filter 41. One byte from the pattern offset can be filtered bit-by-bit with a bit mask value. A bit set to a bit mask value of one is the mask area.

The pattern filter 41 determines whether the packet received from the address filter 40 is the non-print-request packet or the print-request packet; in the case of the non-print-request packet, the PM 32 is notified; and in the case of the non-print-request packet, the PM 32 is notified and the packet is output to the buffer 42 after the above filtering. If the packet received from the address filter 40 is the ARP request packet, a PE_ON signal is sent to the SEL 25, and the ARP request packet is output to the PE 24.

The buffer 42 temporarily stores the packet filtered by the pattern filter 41 and transmits through the internal bus 34 to the units performing processes. The absence of the packet received by the PF 23 can be known by the activation of the empty flag, which is an empty flag indicating that the buffer 42 of the PF 23 is empty.

By setting the pattern of the ARP request packet in the pattern filter 41, the PE_ON signal can be activated. That is, when receiving the ARP request packet, the PE_ON signal is activated and the PE 24 performs the ARP reply response.

If the PE_ON signal is not activated, the packet is accumulated in the memory 11 through the MEMI/F 21 after passing through the PF 23. If a print-request packet or a non-print-request packet other than the ARP request packet is received, the PE_ON signal is not activated.

FIG. 14 is a schematic diagram for explaining an internal operation of the PE 24. The PE 24 includes a packet analyzing unit 50, a register unit 51, and a packet generating unit 52.

The packet analyzing unit 50 inputs the ARP request packet from the PF 23.

The ARP request packet contains a destination MAC address field 60, an SHA 61, an ARP 62, a hardware type field 63, a protocol field 64, a MAC address length field 65, a protocol address length field 66, an ARP request field 67, an SHA 68, a SIP 69, a DHA 70, and a DIP 71.

The packet analyzing unit 50 analyzes values of the source hardware address (SHA) field 68 and the source IP address (SIP) field 69 in the ARP request packet and sets a source hardware address (SHA) and a source IP address (SIP) in a destination hardware address (DHA) 53 and a destination IP address (DIP) 54, respectively, of the register unit 51. The hardware address and the IP address of the printer are preliminarily set from the CPU 20 in a source hardware address (SHA) 55 and a source IP address (SIP) 56, respectively, of the register unit 51.

The packet generating unit 52 generates the ARP response packet containing an Ethernet header 80 and an ARP reply packet 81. The Ethernet header 80 contains a destination hardware address (DHA) field 82, a source hardware address (SHA) field 83, and a type field 84; a value read from the destination hardware address (DHA) 53 of the register unit 51 is set in the DHA 82, and a value read from the source hardware address (SHA) 55 is set in the SHA 83. The type field 84 is set to 0x0806 indicating the ARP packet. An ARP reply packet 81 is set as a data portion.

A hardware type field 85 of the ARP reply packet 81 is set to one in the case of Ethernet. A protocol field 86 is set to 0x0800 since TCP/IP is used. A MAC address length field 87 is set to six. A protocol address length field 88 is set to four since IPv4 is used. An OP field 89 is set to two indicating the ARP reply.

A source hardware address field 90 is set to a value of the SHA 55 of the register unit 51; a source IP address field 91 is set to a value of the SIP 56 of the register unit 51; a destination hardware address field 92 is set to a value of the DHA 53 of the register unit 51; and a destination IP address field 93 is set to a value of the DIP 54 of the register unit 51.

Since the FCS of the Ethernet packet is automatically generated by the MAC 22, the packet generating unit 52 does not have to generate the FCS. To transmit the ARP response packet generated by the packet generating unit 52 to the network, the PE_ON signal output from the PF 23 is activated and the SEL 25 transmits the ARP response packet output from the PE 24 to the MAC 22. When the PE_ON signal is not active, the data from the internal bus 34 are input to the MAC 25.

As above, the ARP response packet generated by the packet generating unit 52 is transmitted through the SEL 25, the MAC 22, and the PHY 12 to the network.

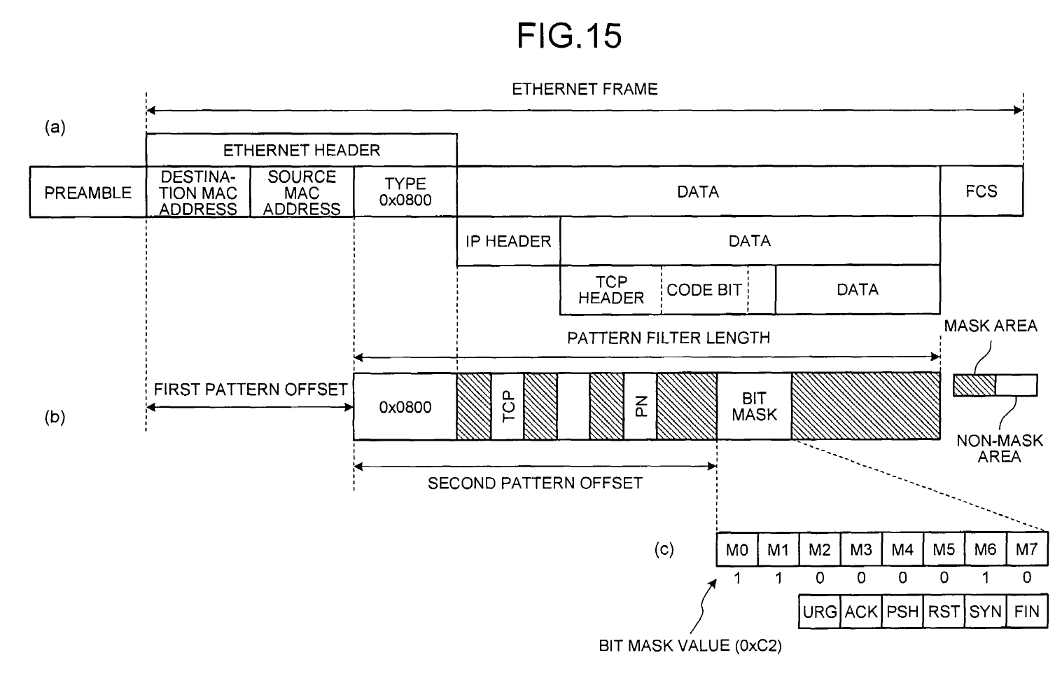

Described below is an example of the filtering process of the TCP packet in the PF 23. FIG. 15 is an example of the TCP packet allowed to pass through in the filtering process of the PF 23. A format of the TCP packet is shown in (a) of FIG. 15. As shown in (b) of FIG. 15, a value obtained by adding the destination MAC address length and the source MAC address length is set as the first pattern offset for the pattern filter 41 of the PF 23.

The pattern filter 41 refers to the type of the first 16 bits of the TCP packet. In the case of the TCP packet, the type is set to 0x0800 indicating the IP protocol.

A comparison value with the IP header of the TCP packet is also set. The protocol number of the IP header is set to the TCP protocol number; the destination IP address is set to the IP address of the printer; and other portions of the IP header are set as the mask areas (portions with diagonal lines in (b) of FIG. 15). A comparison value with the TCP header is also set; the destination port number of the TCP header is set to a port number of the utilized application; and a comparison value with a code bit of the TCP header is set.

Described below is the setting for allowing passage of the TCP packet through the pattern filter 41 when a connection establishment request, i.e., a SYN bit is one. Since the code bits are located at the 14th byte from the top of the TCP header in the TCP packet, the second pattern offset is set to 13 in the pattern filter 41 as shown in (b) of FIG. 15.

By setting 0x02 at the 14th byte of the pattern filter 41, a comparison can be made with the code bit SYN of the TCP packet shown in (c) of FIG. 15. By setting the bit mask value to 0xC2, the TCP packet with the code bit SYN set to one can be allowed to pass through.

Other portions corresponding to the header area of the TCP packet are defined as the mask areas (portions with diagonal lines in (b) of FIG. 15). A portion after the bit mask shown in (b) of FIG. 15 is also set as the mask area (portion with diagonal lines in (b) of FIG. 15).

The destination port number is set to 80 in the case of an http application and the destination port number is set to 515 in the case of LPD, which is a print protocol. When filtering a bit other than SYN, for example, ACK, the bit mask value may be changed to 0xD0. If the destination port number 515 of an LPD application, i.e., a print protocol is set in the pattern filter 41, when the corresponding TCP is received, a print-request signal is activated and the PM 32 is notified.

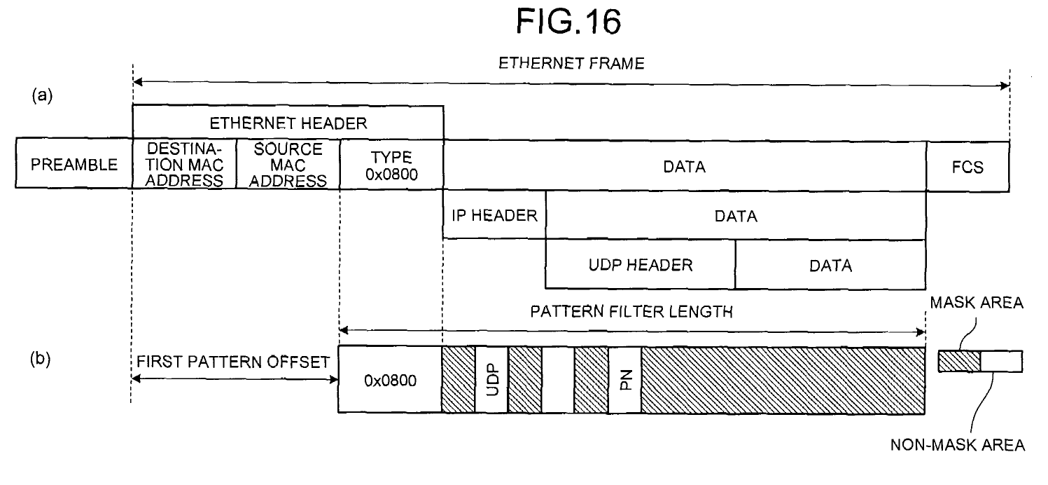

FIG. 16 is a schematic diagram of an example of the UDP packet allowed to pass through in the filtering process of the PF 23. An example of the UDP packet is shown in (a) of FIG. 16. As shown in (b) of FIG. 16, a value obtained by adding the destination MAC address length and the source MAC address length is set as the first pattern offset for the pattern filter 41 of the PF 23. The pattern filter 41 refers to the type of the first 16 bits of the UDP packet. In the case of the UDP packet, the type is set to 0x0800 indicating the IP protocol.

A comparison value with the IP header of the UDP packet is also set. The protocol number of the IP header is set to the UDP protocol number; the destination IP address is set to the IP address of the printer; and other portions of the IP header are set as the mask areas (portions with diagonal lines in (b) of FIG. 16).

A comparison value with a UDP header is also set; the destination port number of the UDP header is set to a port number of the utilized application; and other UDP header areas are set as the mask areas (portions with diagonal lines in (b) of FIG. 16). A portion after the UDP header areas is also set as the mask area (portion with diagonal lines in (b) of FIG. 16).

If the destination port number is set to a port number of an application accessing the MIB information using the SNMP protocol, the filtering can be performed with a port filter when access to the MIB information is attempted.

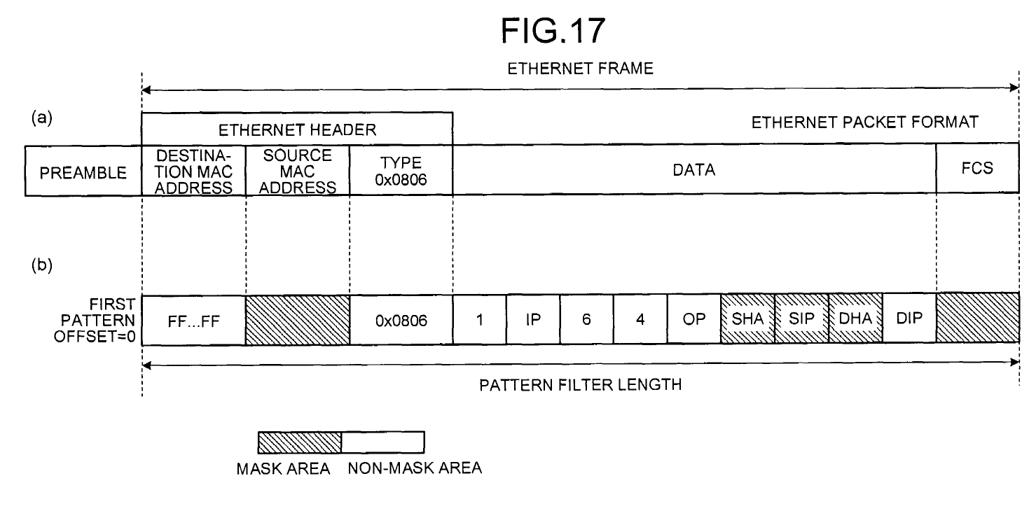

FIG. 17 is a schematic diagram of an example of the ARP packet allowed to pass through in the filtering process of the PF 23. An example of the ARP packet is shown in (a) of FIG. 17. As shown in (b) of FIG. 17, the first pattern offset is set to zero for the pattern filter 41 of the PF 23 so that the comparison can be made from the start of the ARP packet. The pattern filter 41 refers to the type of the first 16 bits of the UDP packet.

A comparison value of the Ethernet header of the ARP packet is set in the pattern filter 41. All bits are set to one in the first part of the frame, which is the destination MAC address, since the ARP protocol is broadcast. The source MAC address is set as the mask area (portion with diagonal lines in (b) of FIG. 17).

Since the type of the Ethernet header is set to 0x0806 indicating the ARP protocol, a comparison value with the type of the ARP packet is set in the pattern filter 41. The hardware type is then set to one; the protocol field is set to IP; the MAC address length is set to six; the protocol address is set to four because of IPv4; and the operation code is set to one indicating an ARP request.

The source hardware address (SHA), the source IP address (SIP), and the destination hardware address (DHA) are set to the mask areas (portions with diagonal lines in (b) of FIG. 17). The destination IP address (DIP) is set to the IP address of the printer, and the remaining portion is set to the mask area (portion with diagonal lines in (b) of FIG. 17).

With the above setting, the filtering can be performed when the ARP request packets are broadcasted to the printer. If the destination port number 80 of an http application, i.e., a non-print protocol and the SNMP protocol are set in the pattern filter 41, when the corresponding ARP request packet is received, the non-print-request signal is activated and the PM 32 is notified. If the ARP packet is set in the pattern filter 41, the PE_ON signal to the SEL 25 is activated when the ARP request packet is received.

As described above, according to the first embodiment, the printer performs a portion of the packet process for the network with a network packet processing unit rather than in a CPU process. Accordingly, the power consumption mode can be maintained in the units including the CPU other than the network packet processing unit. Therefore, the power consumption can be reduced.

The power consumption mode is changed depending on packets, which increases the energy-saving effect. Moreover, because the CPU is built in the ASIC, the power consumption can further be reduced.

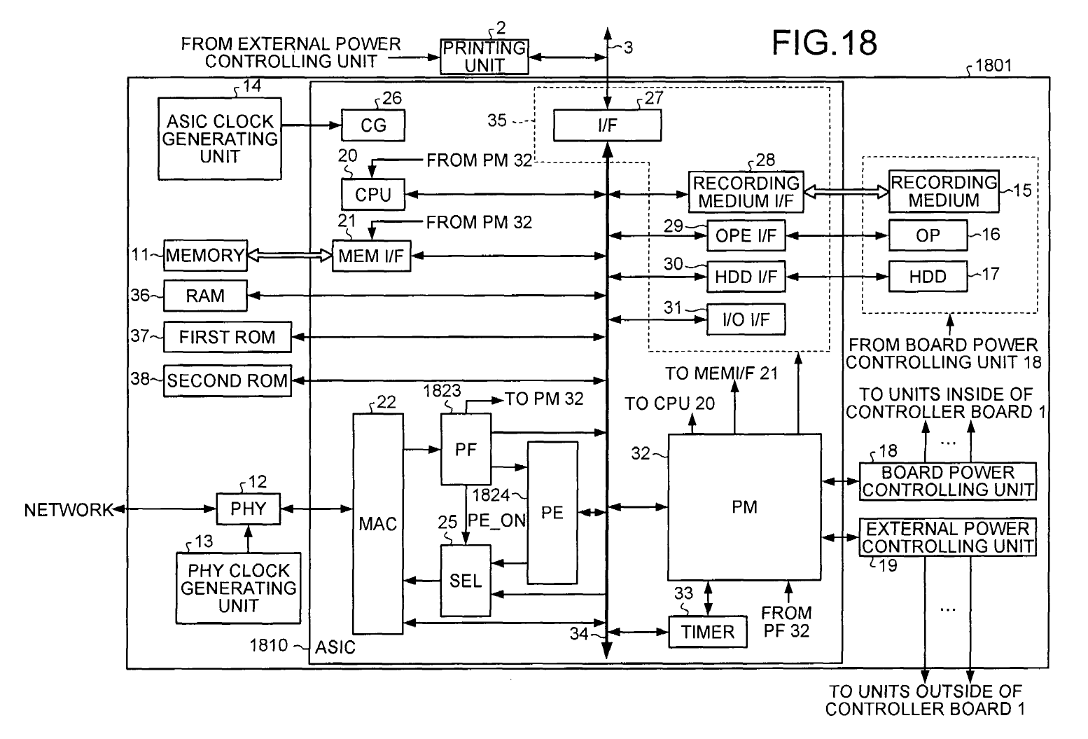

FIG. 18 is a functional block diagram of a controller board 1801 of an information processing apparatus according to a second embodiment of the present invention.

The controller board 1801 is basically similar in configuration to the controller board 1 of the first embodiment except for an ASIC 1810. The ASIC 1810 is of configuration basically the same as previously described for the ASIC 10 except for a PF 1823 and a PE 1824.

The PF 1823 checks the contents of the packet received by the MAC 22 through the PHY 12 from the network and discards the packet if the packet is not addressed to the own printer (station), or sends the packet addressed to the own station to the PE 1824 if the packet is required to be processed by the PE 1824.

The packets to be processed by the PE 1824 include an ARP request of the IP packet, for example.

When receiving the ARP request, the PE 1824 generates a packet of an ARP response based on the contents of the ARP request and transfers the ARP response packet through the SEL 25 and the MAC 22 to the network from the PHY 12.

The packets to be processed by the PE 1824 also include a “Ping command”, which is a packet arrival confirmation command transmitted from the host. When the Ping command is received from the host, a reply is sent to the host for acknowledgement of reception.

The formats of the Ethernet frame, the ARP packet, the IP packet, the TCP packet, the UDP packet received by the printer are the same as those of the first embodiment. An ICMP packet is also received in the second embodiment.

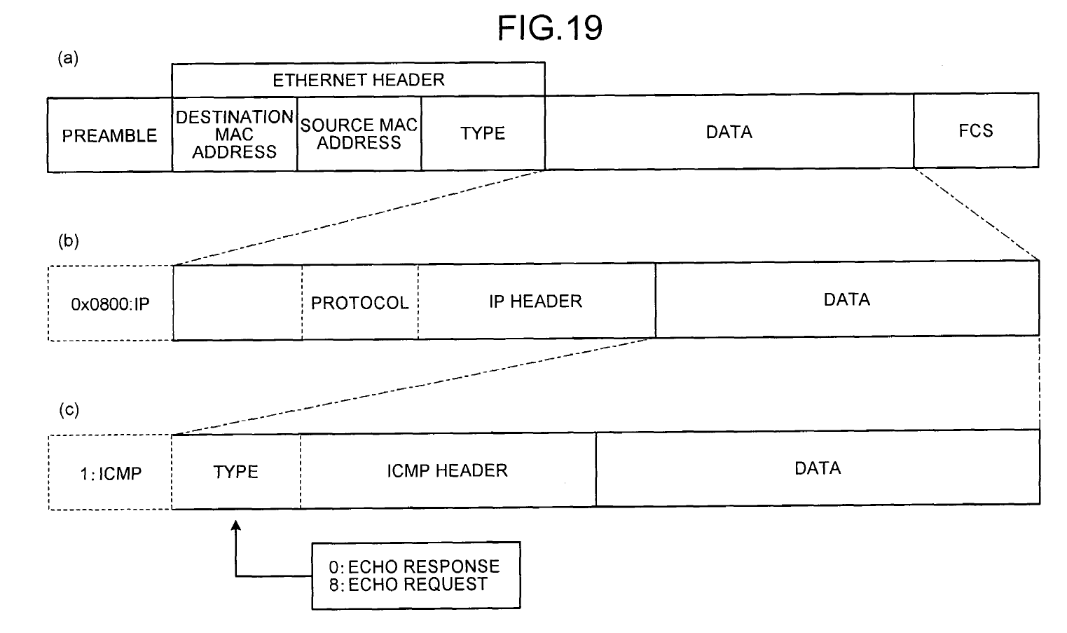

FIG. 19 depicts formats of the IP packet and the ICMP packet in the Ethernet frame. As shown in (a) of FIG. 19, the Ethernet frame contains the preamble, the destination MAC address, the source MAC address, the type, the data, and the FCS, and the destination MAC address, the source MAC address, and the type make up the Ethernet header. The data can be specified in 46 to 1500 byte length, and the FCS is a checksum and is generated by the CRC-32 polynomial.

As shown in (b) of FIG. 19, to create the IP packet, the IP header and the data are included in the data of the Ethernet frame. The type of the Ethernet header indicates 0x0800, which is data indicating the IP protocol as shown by a dashed line in (b) of FIG. 19.

As shown in (c) of FIG. 19, to create the ICMP packet, the ICMP packet is encapsulated in the data portion of the IP packet, and the data portion includes a type, an ICMP header, and data of the ICMP packet.

The type is “8” in the case of an ICMP echo request (echo request) packet and “0” in the case of an ICMP echo reply (echo response) packet. In the ICMP header, “0” is always stored as the code bit of the ICMP echo request packet and the ICMP echo reply packet. Although the data have an arbitrary length, the data normally have a data length of 64 bytes. The protocol of the IP header indicates one, which is the data indicating the ICMP as shown by a dashed line in (c) of FIG. 19.

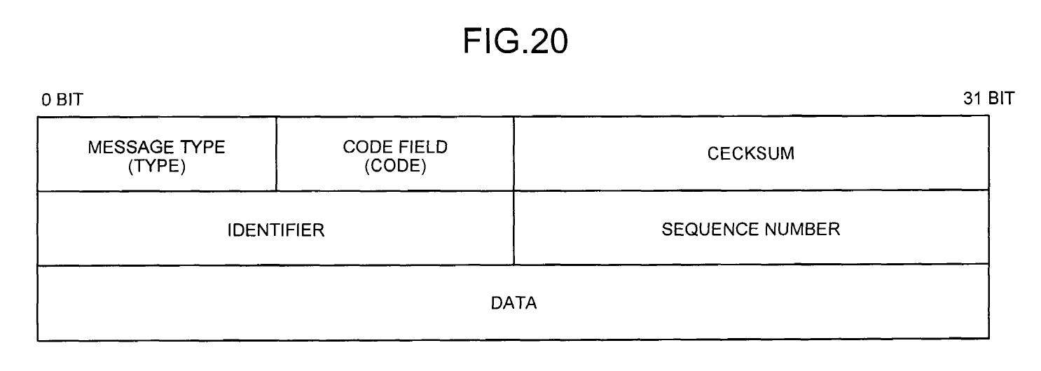

FIG. 20 depicts a format of the ICMP echo request and ICMP echo reply packets. The ICMP echo request and ICMP echo reply packets contain a message type field, a code field, a checksum field, an identifier field, a sequence number field, and data.

Although the ICMP echo packets are well-known and are not be described in detail, the message type field is an area having “8” stored in the case of the ICMP echo request packet and “0” stored in the case of the ICMP echo reply packet. The code field is an area always having “0” stored in the case of the ICMP echo request packet and the ICMP echo reply packet as described above.

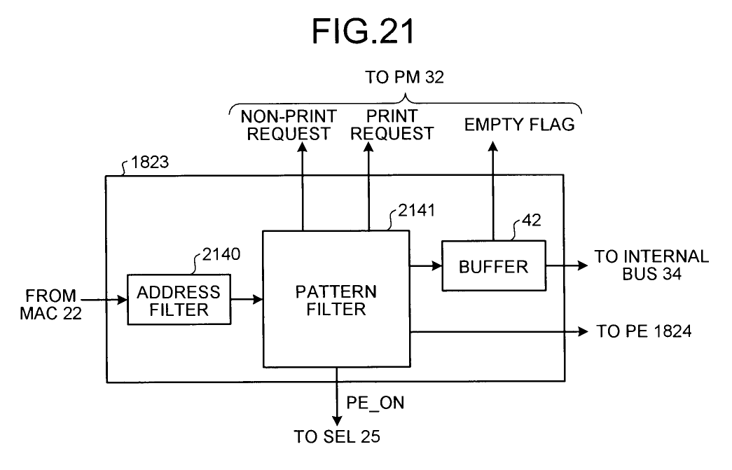

FIG. 21 is a block diagram of the PF 1823. The PF 1823 includes an address filter 4210, a pattern filter 2141, and the buffer 42.

To the address filter 2140, a unicast address and a multicast address can be registered. Addresses of devices including the printing unit 2 accessible in the printer can also be set.

The address filter 2140 screens packets by referring to types of packets input from the MAC 22, determining kinds of packets from the types, allowing passage of only packets for accessible devices, sending the packets to the pattern filter 2141, and discarding other packets. The address filter 2140 of this embodiment determines from the types of packets whether the kind of packets is the ICMP packet, in addition to the kinds of packet determined by the address filter 40 of the first embodiment. Broadcast packets are allowed to pass and sent to the pattern filter 2141 regardless of the setting of the address filter 2140.

The pattern filter 2141 includes the mask area and the non-mask area as is the case with the first embodiment. The process of the pattern filter 2141 is performed in the same manner as in the first embodiment. Although the pattern filter 2141 determines whether a packet received form the address filter 2140 is a non-print-request packet of a print-request packet as is the case with the first embodiment, if the received packet is the ICMP packet, the packet is determined as the non-print-request packet in this embodiment. The buffer 42 has the same function as the first embodiment.

When filtering the ARP packet, the PE 1824 performs the same internal operation as previously described in the first embodiment. That is, the PE 1824 includes the packet analyzing unit 50, the register unit 51, and the packet generating unit 52 similarly to the PE 24.

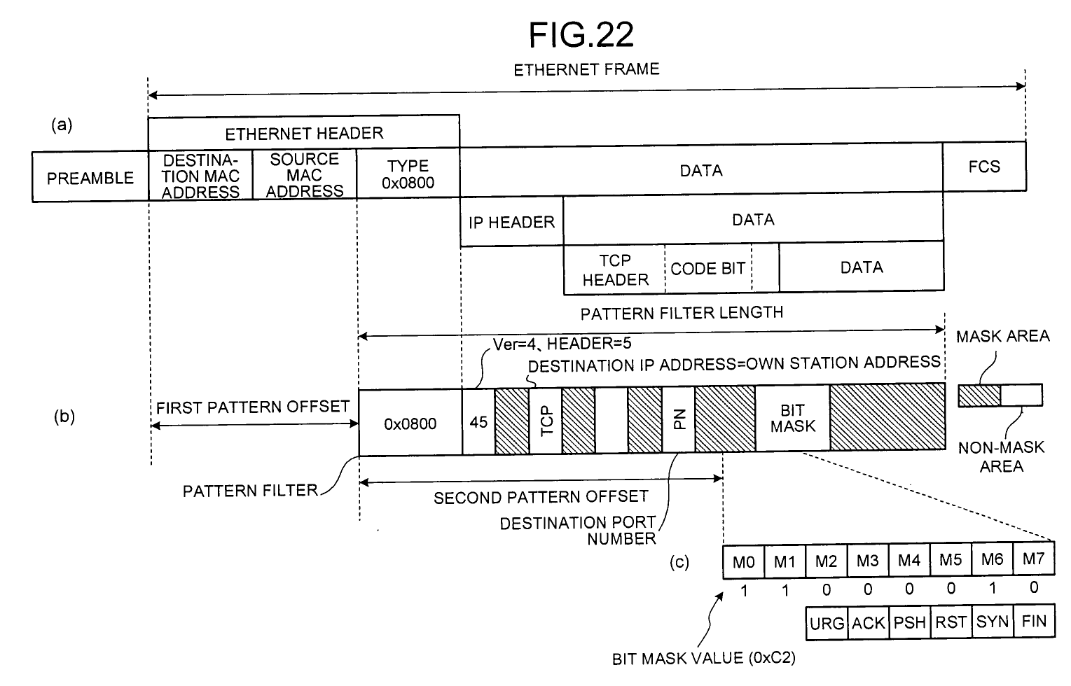

FIG. 22 is a schematic diagram of an example of the TCP packet allowed to pass through in the filtering process of the PF 1823. A format of a network frame of the TCP packet is shown in (a) of FIG. 22. As shown in (b) of FIG. 22, a value obtained by adding the destination MAC address length and the source MAC address length is set as the first pattern offset for the pattern filter 2141 of the PF 1823.

The pattern filter 41 refers to the type of the first 16 bits of the TCP packet. In the case of the TCP packet, the type is set to 0x0800 indicating the IP protocol in the first 16 bits.

A comparison value with the IP header of the TCP packet is also set. The version (Ver) of the IP header is set to IPv4; the header length is set to five; the protocol number is set to the TCP protocol number; the destination IP address is set to the IP address of the printer (the own station address); and other portions of the IP header are set as the mask areas (portions with diagonal lines in (b) of FIG. 22).

A comparison value with the TCP header is also set; the destination port number of the TCP header is set to a port number of the utilized application; and a comparison value with a code bit of the TCP header is set.

Described below is the setting for allowing passage of the TCP packet through the pattern filter 2141 when a connection establishment request, i.e., a SYN bit is one. Since the code bits are located at the 14th byte from the top of the TCP header in the TCP packet, the second pattern offset is set to 13 in the pattern filter 2141 as shown in (b) of FIG. 22.

By setting 0x02 at the 14th byte of the pattern filter 41, a comparison can be made with the code bit SYN of the TCP packet shown in (c) of FIG. 22.

By setting the bit mask value to 0xC2, the TCP packet with the code bit SYN set to one can be allowed to pass through.

Other portions corresponding to the header area of the TCP packet are defined as the mask areas (portions with diagonal lines in (b) of FIG. 22). A portion after the bit mask shown in (b) of FIG. 22 is also set as the mask area (portion with diagonal lines in (b) of FIG. 22). The destination port number is set to 80 in the case of an http application and the destination port number is set to 515 in the case of LPD, which is a print protocol. When filtering a bit other than SYN, for example, ACK, the bit mask value may be changed to 0xD0.

If the destination port number 515 of an LPD application, i.e., a print protocol is set in the pattern filter 2141, when the corresponding TCP is received, a print-request signal is activated and the PM 32 is notified.

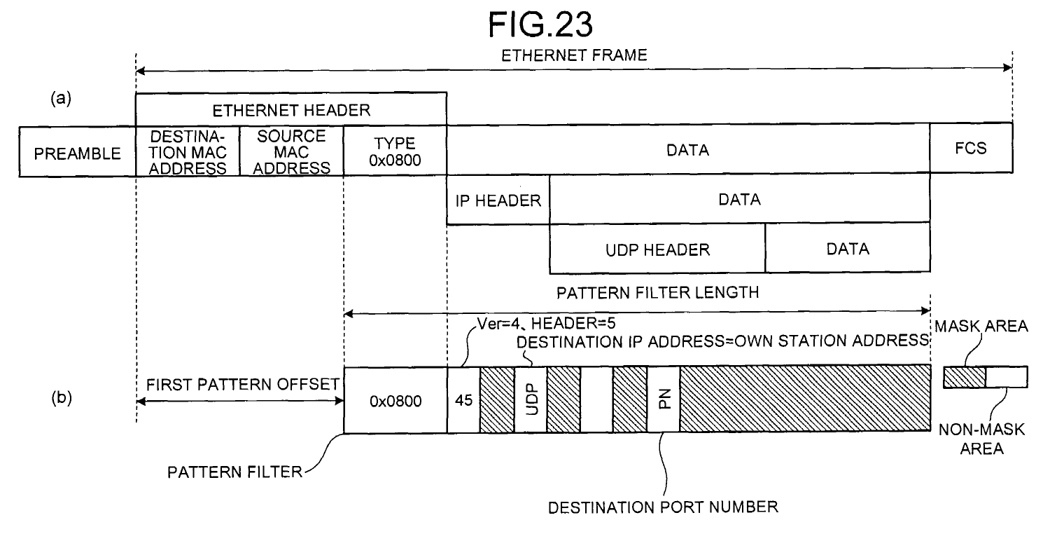

FIG. 23 is a schematic diagram of an example of the UDP packet allowed to pass through in the filtering process of the PF 1823.

An example of the UDP packet is shown in (a) of FIG. 23. As shown in (b) of FIG. 23, a value obtained by adding the destination MAC address length and the source MAC address length is set as the first pattern offset for the pattern filter 2141 of the PF 23.

The pattern filter 2141 refers to the type of the first 16 bits of the UDP packet. In the case of the UDP packet, the type is set to 0x0800 indicating the IP protocol in the first 16 bits.

A comparison value with the IP header of the UDP packet is also set. The version (Ver) of the IP header is set to IPv4; the header length is set to five; the protocol number is set to the UDP protocol number; the destination IP address is set to the IP address of the printer (the own station address); and other portions of the IP header are set as the mask areas (portions with diagonal lines in (b) of FIG. 23).

A comparison value with the UDP header is also set; the destination port number of the UDP header is set to a port number of the utilized application; and other UDP header areas are set as the mask areas (portions with diagonal lines in (b) of FIG. 23). A portion after the UDP header areas is also set as the mask area (portion with diagonal lines in (b) of FIG. 23).

If the destination port number is set to a port number of an application accessing the MIB information using the SNMP protocol, the filtering can be performed with a port filter when access to the MIB information is attempted.

An example of the ARP packet allowed to pass through in the filtering process of the PF 1823 is the same as the first embodiment.

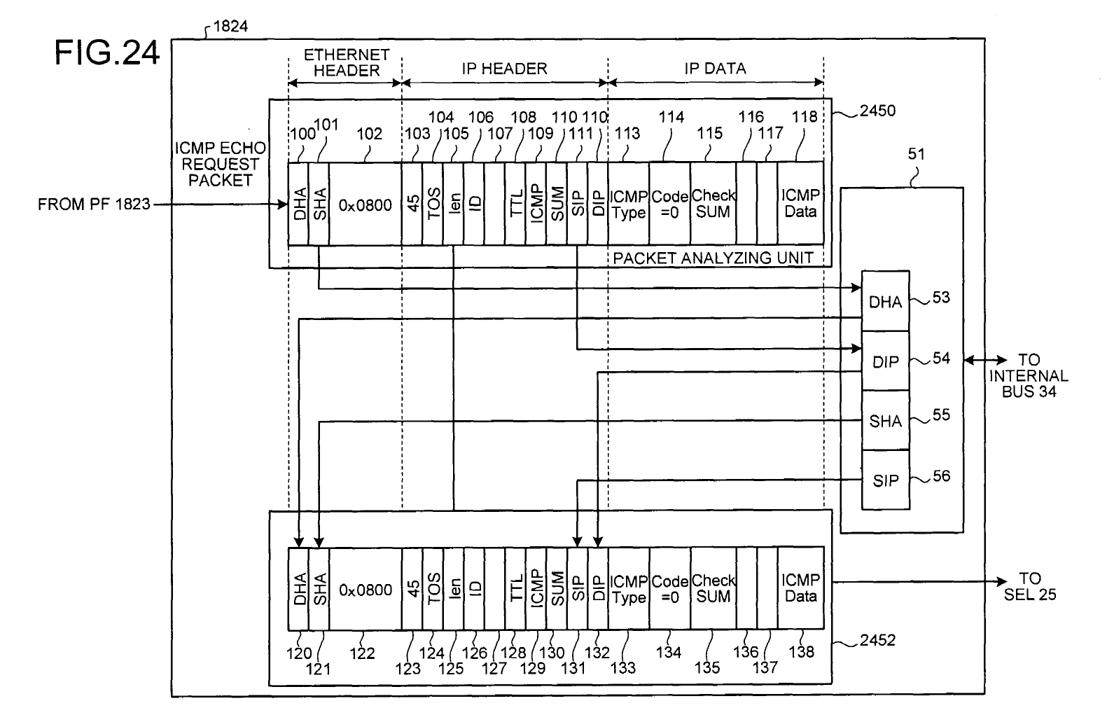

FIG. 24 is a schematic diagram for explaining an internal operation of the PE 1824 for filtering the ICMP packet. Like reference numerals refer to the portions corresponding to those in FIG. 14.

In this process, the PE 1824 includes a packet analyzing unit 2450, the register unit 51, and a packet generating unit 2552. The register unit 51 is the same as that of the first embodiment. To the packet analyzing unit 2450, an ICMP echo request packet is input from the PF 1823 in this case. The ICMP echo request packet contains fields 100 to 118.

The packet analyzing unit 2450 analyzes values of the source hardware address (SHA) in the field 101 of the Ethernet header and the source IP address (SIP) in the field 111 of the IP header in the ICMP echo request packet and sets the source hardware address (SHA) and the source IP address (SIP) in a destination hardware address (DHA) 53 and the destination IP address (DIP) 54, respectively, of the register unit 51.

In the field 113 of the type of the IP data, “8” is stored to indicate the ICMP echo request packet.

The hardware address and the IP address of the printer are preliminarily set from the CPU 20 in the source hardware address (SHA) 55 and the source IP address (SIP) 56, respectively, of the register unit 51.

The packet generating unit 2452 generates an ICMP echo reply packet. First, when generating the Ethernet header thereof, the source hardware address (SHA) set in the DHA 53 and the hardware address set in the SHA 55 of the register unit 51 are set in a field 120 of the DHA and a field 121 of the SHA, respectively, of the Ethernet header of the ICMP echo reply packet in the packet generating unit 52.

From the field 102 of the type of the ICMP echo request packet, 0x800 indicating IP is copied to a field 122 of the ICMP echo reply packet in the packet generating unit 2452.

The IP header is then generated for the ICMP echo reply packet in the packet generating unit 2452. First, the data in the fields 103 to 109 of the ICMP echo request packet in the packet analyzing unit 2450 are copied to fields 123 to 127 and 129, respectively, of the IP header of the ICMP echo reply packet in the packet generating unit 2452. TTL of a field 128 is set to 255. After the copying, a checksum is calculated and set in a field 130 of the ICMP echo reply packet.

The checksum may be calculated by using a known technology (e.g., one's complement operation method described in “Mastering TCP/IP: Applications” published by Ohmsha).

The data of the SIP 56 of the register unit 51 are set in a field 131 of the SIP and the data of the DIP 54 of the register unit 51 are set in a field 132 of the DIP.

The packet generating unit 2452 then generates IP data of the ICMP echo reply packet. In a field 133 of the type of the ICMP echo reply packet in the packet generating unit 2452, “0” is set to indicate the ICMP echo reply packet.

A field 134 of the code of the ICMP echo reply packet is set to “0” in the packet generating unit 52, and a checksum of the IP data is calculated and set in a field 135 of the checksum. The checksum may be calculated by using a known technology (e.g., one's complement operation described in “Mastering TCP/IP: Applications” published by Ohmsha).

The identifier data in the field 116 of the ICMP echo request packet in the packet analyzing unit 2450 are copied to a field 136 of the ICMP echo reply packet in the packet generating unit 2452; the sequence number data in the field 117 of the ICMP echo request packet in the packet analyzing unit 2450 are copied to a field 137 of the ICMP echo reply packet in the packet generating unit 2452; and the data in the field 118 of the ICMP echo request packet in the packet analyzing unit 2450 are copied to a field 138 of the ICMP echo reply packet in the packet generating unit 2452. This enables the ICMP echo reply packet to be generated and returned without using the CPU and the memory in the main body of the printer.

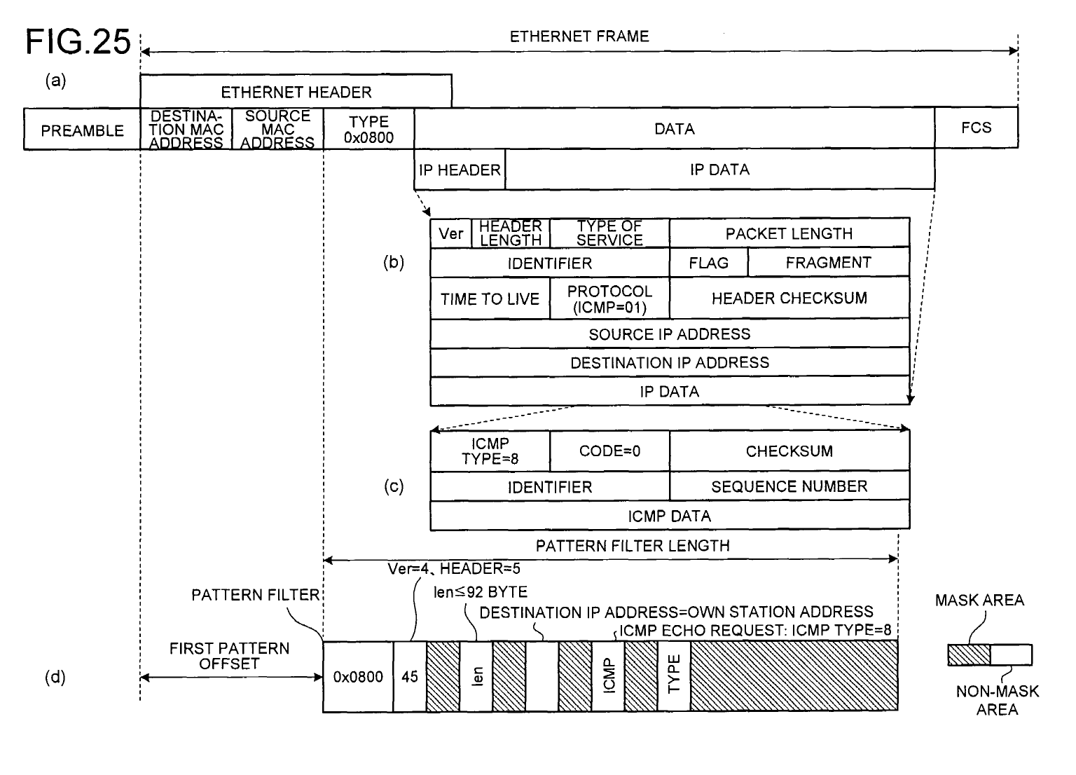

FIG. 25 is a schematic diagram of an example of the ICMP packet allowed to pass through in the filtering process of the PF 1823.

A format of a network frame of the ICMP packet is shown in (a) of FIG. 25. As shown in (b) of FIG. 25, a format of the IP header thereof contains fields that respectively store values of a version (Ver), a header length, a type-of-service, a packet length, an identifier, a flag, a fragment, a time-to-live, a protocol (in this case, “01” indicating ICMP), a header checksum, a source IP address, and a destination IP address. As shown in (c) of FIG. 25, a format in the IP data contains fields that respectively store values of a type (in this case, a type indicating the ICMP echo request packet=8), a code (always zero), a checksum, an identifier, a sequence number, and ICMP data. The type is zero when indicating the ICMP echo reply packet.

As shown in (d) of FIG. 25, a value obtained by adding the field length of the destination MAC address and the field length of the source MAC address is set as the first pattern offset for the pattern filter 2141 of the PF 1823.

In the pattern filter 2141, the first 16 bits after the first pattern offset are set to “0x0800” indicating the IP protocol stored in the type of the Ethernet header of the Ethernet frame shown in (a) of FIG. 25. The setting also includes “4” indicating IPv4 stored in the version (Ver) field of the IP header of the Ethernet frame shown in (b) of FIG. 25 and “5” stored in the header length field of the IP header.

The protocol number is set to the ICMP number; the destination IP address is set to the own station address, i.e., the IP address of the printer; the ICMP type is set to “8” indicating ICMP echo request packet; and other portions of the IP header are set as the mask areas (portions with diagonal lines in (b) of FIG. 22).

However, a comparison value len of the packet length of the IP header is set to 92 bytes or less.

The 92 bytes correspond to the case when the ICMP data size is 64 bytes and the IP header length is 20 bytes.

With the above setting, since the PF 23 monitors the packet data from the network, if the PF 1823 receives the ICMP packet data equal to or less than 64 bytes, it can be detected that the packet is the ICMP echo request packet due to PING and the PE 1824 can be notified.

While maintaining the power-saving mode, the ICMP echo reply packet for the ICMP echo request packet can be output through the network to perform the PING response to a source host apparatus of the ICMP echo request packet.

If the size of the ICMP packet data exceeds 64 bytes, the PF 1823 notifies the PM 32 of reception of the non-print-request packet and accumulates the packet into the buffer 42.

In this case, a process is performed after the transition to the power-saving mode. Since the size of the ICMP packet data is normally 64 bytes, no practical problem occurs if a circuit is designed such that the PING packet is detected only when the ICMP packet data are 64 bytes to simplify the hardware.

Described below is a multicast address with the destination IP address registered in the address filter. In the case of a registered multicast address, filters are prepared by the number of registrations to set the registered multicast address in the destination IP address. The setting other than that of the destination IP address is the same as above.

If the ICMP echo request packet (with the ICMP data size equal to or less than 64 bytes) is set in the pattern filter 2141, the PE_ON signal is activated when receiving the ICMP echo request packet (with the ICMP data size equal to or less than 64 bytes).

To transmit the above packet generated by the packet generating unit 2452, the PE_ON signal output from the PF 1823 is activated and the selector (SEL) 25 transmits the output from the PE 1824 to the MAC 22. When the PE_ON signal is not activated, the data from the internal bus 34 are input to the MAC 22.

By setting the pattern of the ARP request packet in the pattern filter 2141 of the PF 1823, the PE_ON signal can be activated. That is, when receiving the ARP request packet, the PE_ON signal is activated and the PE 1824 generates and outputs the ARP reply packet to a source apparatus of the ARP request packet.

When receiving the ICMP echo request packet (with the ICMP data size equal to or less than 64 bytes), the PE_ON signal is activated and the PE 24 generates and outputs the ICMP echo reply packet to a source apparatus of the ICMP echo request packet.

On the other hand, if the PE_ON signal is not activated, the packet is accumulated in the memory 11 through the MEMI/F 21 after passing through the PF 1823.

If a print-request packet or non-print-request other than the ARP request packet and the ICMP echo request packet (with the ICMP data size equal to or less than 64 bytes) is received, the PE ON signal is not activated.

The response Ethernet packet generated by the packet generating unit 2452 is transmitted to the source host apparatus of the above request packet through the selector (SEL) 25, the MAC 22, and the PHY 12.

As described above, according to the second embodiment, if a received packet requests to return predetermined information, a response packet is generated by incorporating a portion of information of the received packet to perform the response process without using the CPU and the memory of the printer. Therefore, the power consumption can be reduced in the CPU and the memory in the main body of the printer.

A response is made when the size of the received packet is equal to or less than a predetermined size, which lowers the hardware costs of the printer. Thus, the power consumption and the costs can be reduced. A response packet is generated by incorporating a portion of information of the received packet to perform the response process without using the CPU and the memory of the printer in the controller mode and the energy-saving mode. This also reduces the power consumption in the CPU and the memory in the main body of the printer.

Moreover, the identifier, the sequence number, and the ICMP header of a packet can be generated without using the CPU and the memory of the printer. Thus, the power consumption can further be reduced.

Furthermore, the printer performs a portion of the packet process for the network with the network packet processing unit rather than in the CPU process, and therefore, the power consumption mode can be maintained in the units including the CPU other than the network packet processing unit. This also reduces the power consumption. Because the power consumption mode is changed depending on packets, the energy-saving effect can be increased. Besides, the CPU is built in the ASIC, which further reduces the power consumption.

Although the printer is explained in the above embodiments that has energy-saving mode and controller mode as power saving modes, the present invention can also be applied to other types of information processing apparatuses having other modes than energy-saving mode and controller mode as power-saving mode.

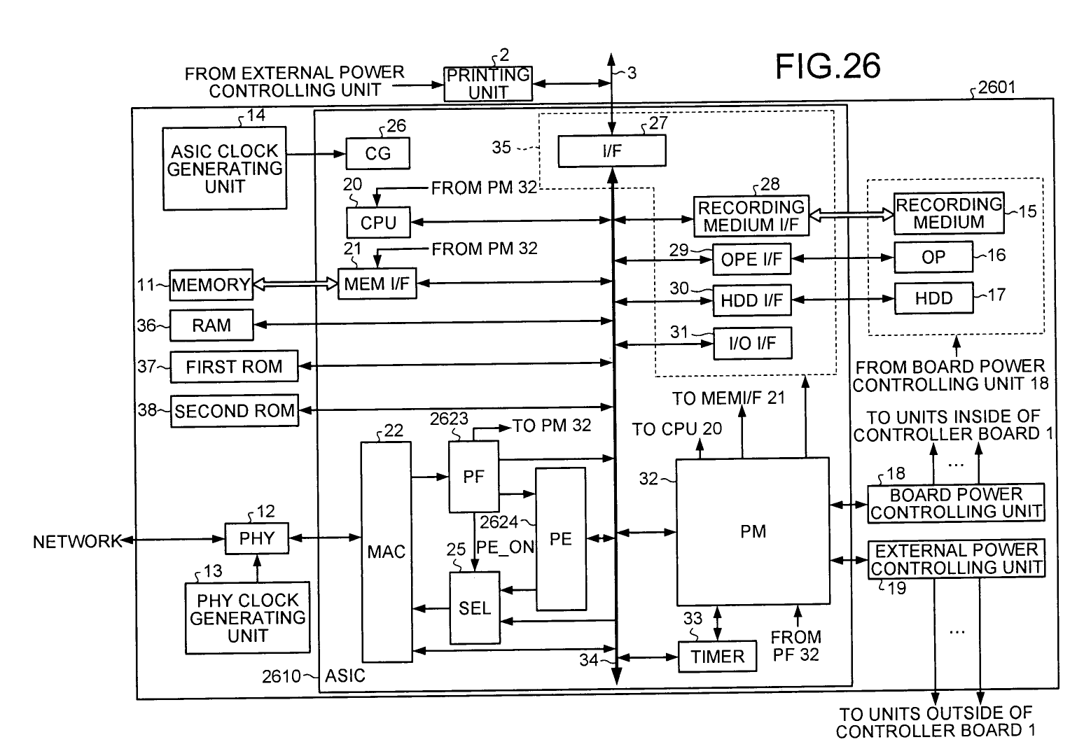

FIG. 26 is a functional block diagram of a controller board 2601 of an information processing apparatus according to a third embodiment of the present invention.

The controller board 2601 is basically similar in configuration to the controller board 1 of the first embodiment except for an ASIC 2610. The ASIC 2610 is of configuration basically the same as previously described for the ASIC 10 and the ASIC 1810 except for a PF 2623 and a PE 2624.

A PF 2623 checks the contents of the packet received by the MAC 22 through the PHY 12 from the network and discards the packet if the packet is not addressed to the own printer (station), or sends the packet addressed to the own station to a PE 2624 if the packet should be processed by the PE 2624.

That is, although the pattern filter of the PF 2623 determines whether the packet received from the address filter is a non-print-request packet or a print-request packet as is the case with the first and second embodiments, it is determined in this embodiment that the packet is a non-print-request packet if the received packet is a management information block (MIB) request packet of the SNMP protocol.

In this embodiment, the packets to be processed by the PE 2624 include the MIB request packet in addition to the types of the packets described in the first and second embodiments. When receiving the MIB request packet from the host, the PE 2624 of the PF 2623 returns a reply to the host for acknowledgement of reception.

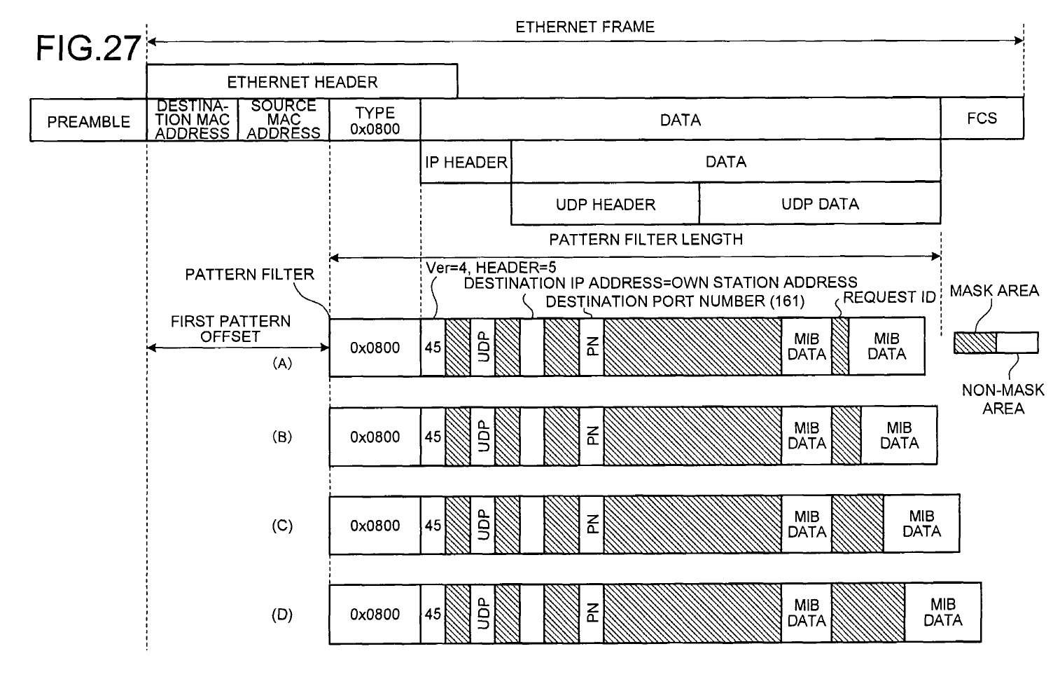

FIG. 27 is a schematic diagram of an example of a packet allowed to pass through in the filtering process of the PF 2623.

In a pattern filter (not shown) of the PF 2623, a value obtained by adding the destination MAC address length and the source MAC address length is set as the first pattern offset shown in FIG. 27. The pattern filter of the PF 2623 refers to the type of the first 16 bits of the packet. In the case of the TCP packet, the type is set to 0x0800 indicating the IP protocol in the first 16 bits.

The field next to the type of the Ethernet header is set to a comparison value of the IP header. The version of the IP header is set to four indicating IPv4; the head length is set to five; the protocol number is set to the UDP protocol number; and the destination IP address is set to an IP address of MFP/LP. Other portions of the IP header are set as the mask areas.

The next field is set to a comparison value of the UDP header. The destination port number of the UDP header is set to a port number of the utilized application. Since the SNMP protocol is used in the case of the MIB response, the number is set to the port number of SNMP, i.e., 161. Other UDP header areas are defined as the mask areas.

MIB data necessary for the MIB response are set in a UDP data portion. The MIB data to be set are the following values of SNMPv2.

mib-2.25.3.2.1.5.1

mib-2.25.3.5.1.1.1

mib-2.25.3.5.1.2.1

Since the data length of the request ID of the MIB request is variable, four patterns are set for each request ID. MIB data other than the request ID of the MIB request are set in the pattern filter and the request ID portion is set to the mask area.

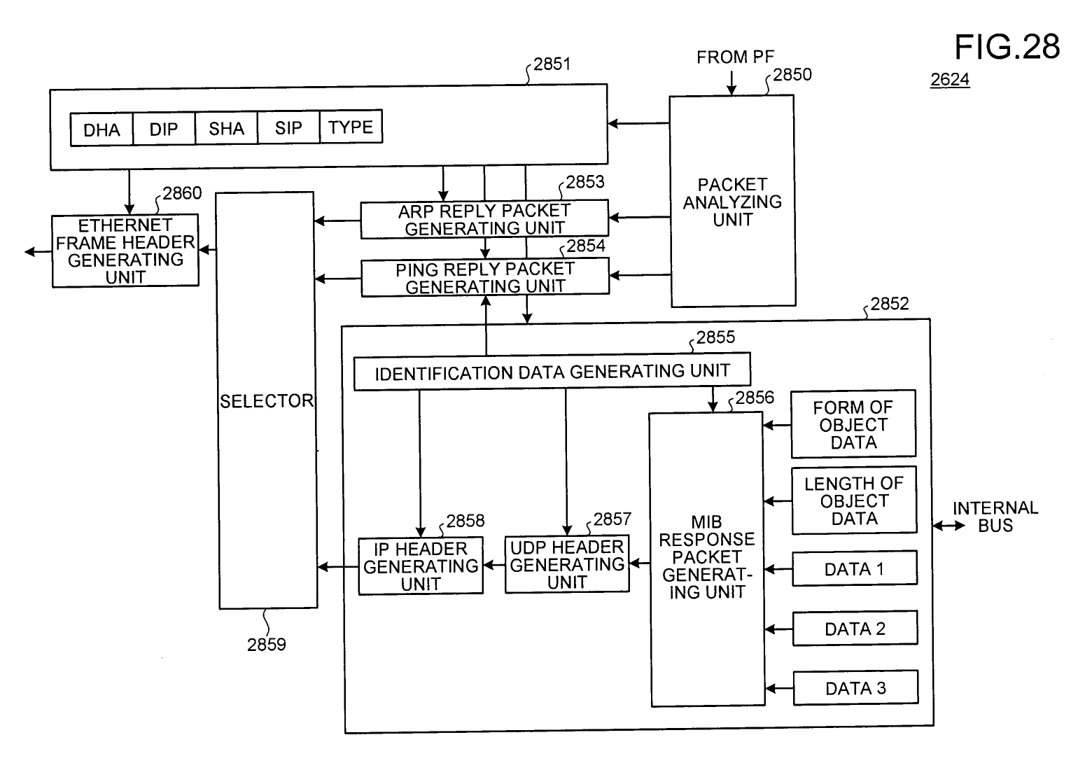

FIG. 28 is a block diagram of the PE 2624. The PE 2624 includes a packet analyzing unit 2850, an ARP reply packet generating unit 2853, a PING reply packet generating unit 2854, an IP packet generating unit 2852, a selector 2859, and an Ethernet frame header generating unit 2860.

The ARP reply packet generating unit 2853 is a unit generating an ARP reply packet and, specifically, includes the same function as the packet generating unit 53 of the first embodiment. The PING reply packet generating unit 2854 is a unit generating a PING packet and, specifically, includes the same function as the packet generating unit of the second embodiment.

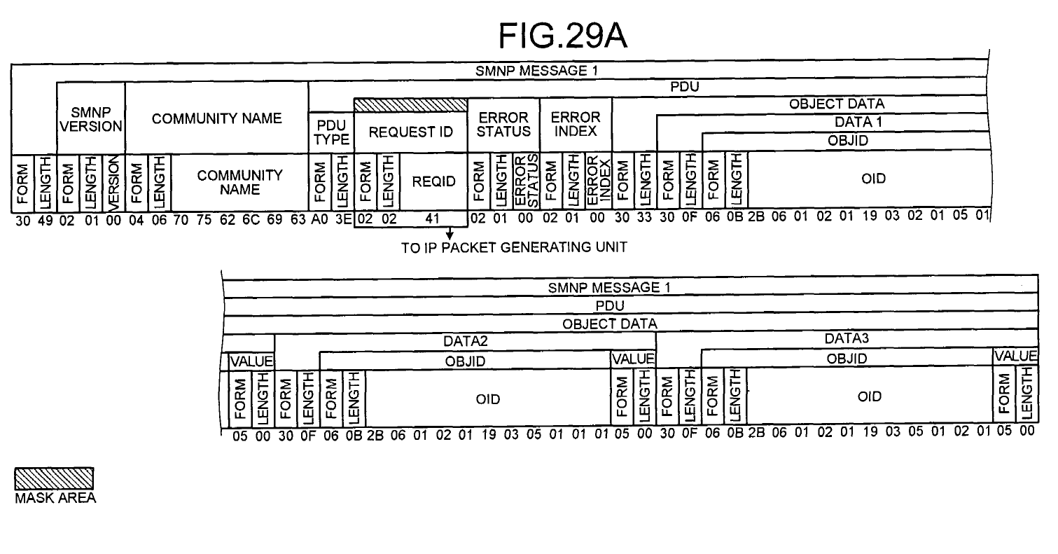

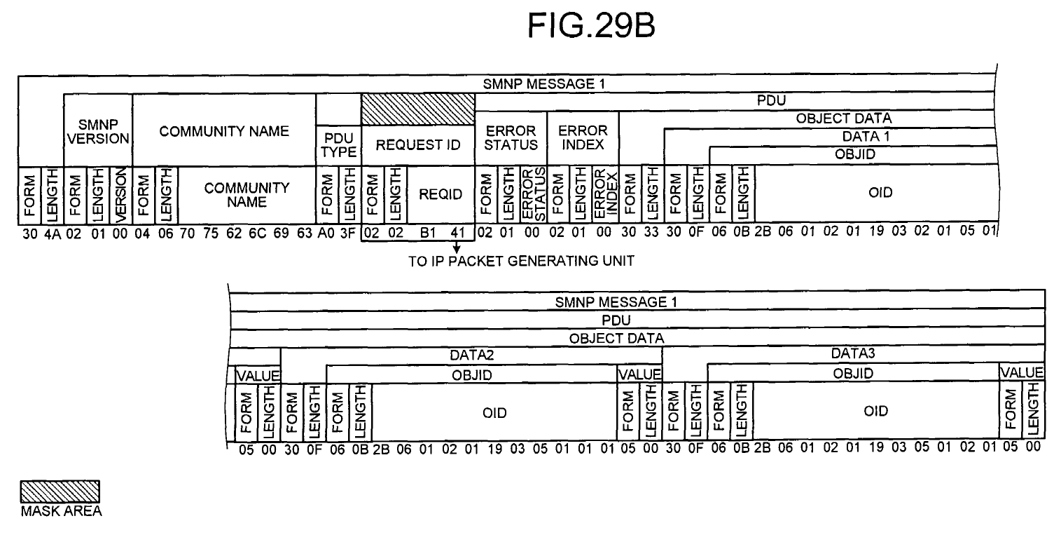

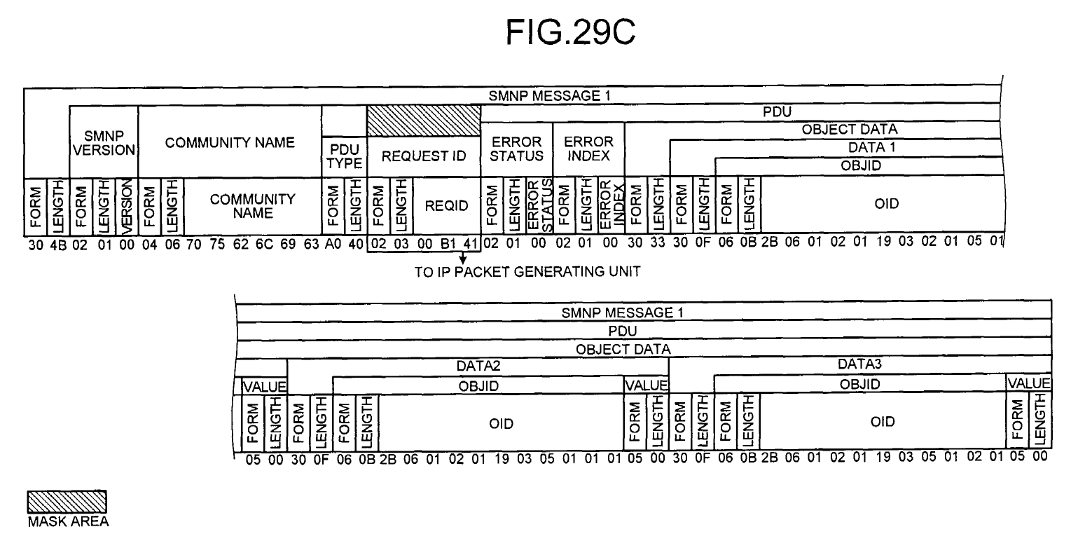

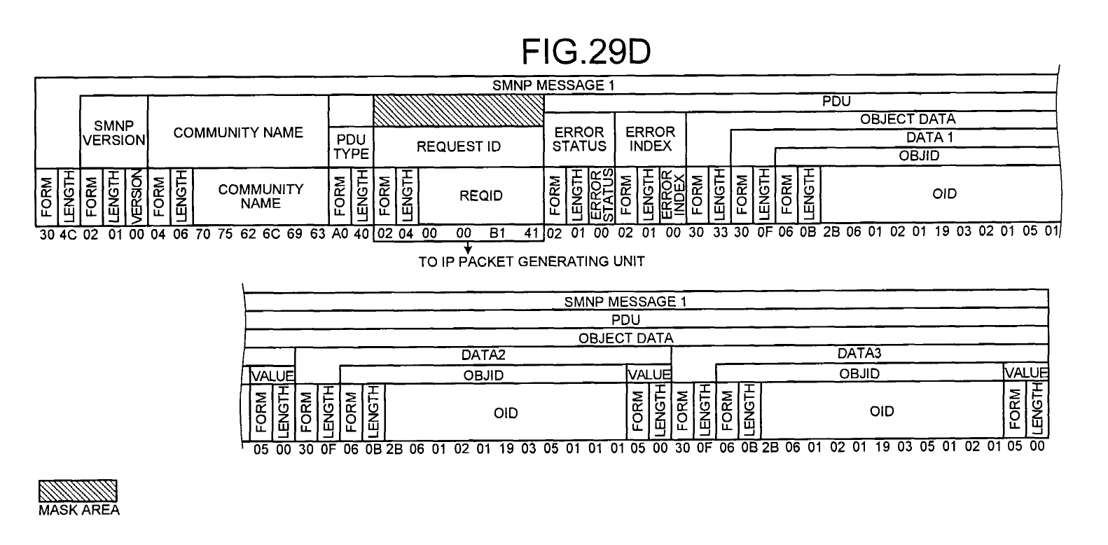

The packet analyzing unit 2850 inputs the data of the MIB request packet from the PF 2623. FIGS. 29A to 29D are schematic diagrams of the MIB request packet. FIG. 29A depicts the MIB request packet when a request ID length is one. FIG. 29B depicts the MIB request packet when a request ID length is two. FIG. 29C depicts the MIB request packet when a request ID length is three. FIG. 29D depicts the MIB request packet when a request ID length is four. The request ID portions (shaded areas in FIGS. 29A to 29D) are the mask areas.

The packet analyzing unit 2850 can detect the MIB request packet corresponding to the four types of request ID length with a filter by setting the four patterns of the MIB request.

The packet transferred from the PF 2623 is analyzed by the packet analyzing unit 2850, and the source port number of the UDP header and the request ID are transferred to an identification data generating unit 2855 of the IP packet generating unit 2852. The source hardware address (SHA) of the Ethernet header is set in the DHA of a register unit 2851, and the source IP address (SIP) of the IP header is set in the DIP of the register unit 2851.

The IP packet generating unit 2852 is a unit generating the IP packet of the MIB response and includes the identification data generating unit 2855, an MIB response packet generating unit 2856, a UDP header generating unit 2857, and an IP header generating unit 2858.

The identification data generating unit 2855 receives the source port number of the UDP header and the request ID and transfers the source port number of the UDP header and a form, a length (len_reqed), and REQID of the request ID to the MIB response packet generating unit 2856.

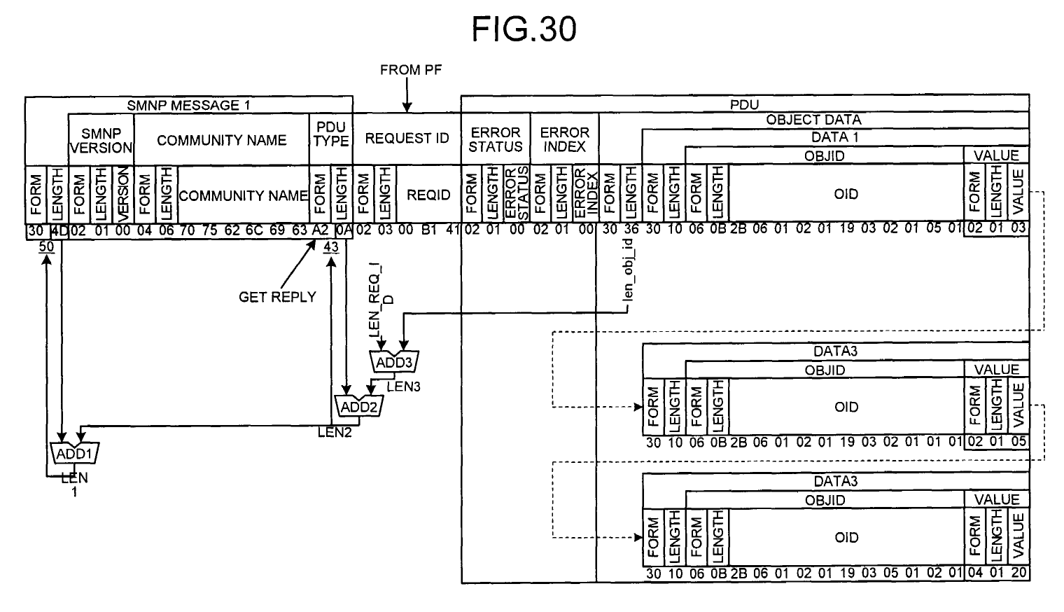

The MIB response packet generating unit 2856 is a unit generating the MIB response packet that is the UDP data portion. FIG. 30 is a schematic diagram for explaining the operation of the MIB response packet generating unit 2856.

The MIB response packet generating unit 2856 sets a form, a length, an SNMP version, a community name, and a Protocol Data Unit (PDU) TYPE in an SNMP message 1. The MIB response packet generating unit 2856 sets an initial length value to 4d since the request ID of the MIB response packet has a variable length.

The MIB response packet generating unit 2856 sets a form of the PDU TYPE to A2 indicating a GET reply because of the MIB response. The MIB response packet generating unit 2856 sets a length of the PDU type to 0a for an initial value.

The MIB response packet generating unit 2856 sets the form, the length (len_reqed), and the REQID received from the identification data generating unit 2855.

The MIB response packet generating unit 2856 sets the same values as the filter setting of the MIB request for an error status and an error index of the PDU.

The MIB response packet generating unit 2856 sets the following object data of the PDU with the CPU.

Data 1: mib-2.25.3.2.1.5.1

Data 2: mib-2.25.3.5.1.1.1

Data 3: mib-2.25.3.5.1.2.1

If the MIB request packet is received during the energy-saving mode, the mode is shifted to the controller mode only at the time of the first MIB response and the CPU sets the object data. The CPU also sets forms and lengths of the data 1, 2, and 3 of the object data and a form and a length (len_objid) of the whole object data.

The MIB response packet generating unit 2856 then calculates a data length of the MIB data. When the CPU sets the length (len_objid) of the entire object data, a sum of the length (len_objid) of entire the object data and the length (len_reqed) of the request ID is calculated as len3 in an ADD 3. The MIB response packet generating unit 2856 then calculates a sum of the len3 and an initial value (0a) of the length of the PDU TYPE as len2 in an ADD 2 and resets len2 to the length of the PDU TYPE. The MIB response packet generating unit 2856 calculates a sum of the initial value (4d) of the length of the SNMP message 1 and len2 as len1 in the ADD 3 and resets len1 to the length of the SNMP message.

The MIB response packet generating unit 2856 generates the MIB response packet as above. The MIB response packet is SNMP data and serves as the UDP data portion as above.

The UDP header generating unit 2857 adds the UDP header to the MIB response packet serving as the UDP data portion. The IP header generating unit 2858 adds the IP header to the MIB response packet having the UDP header added to complete the IP packet for the MIB response and sends out the IP packet to the selector 2859.

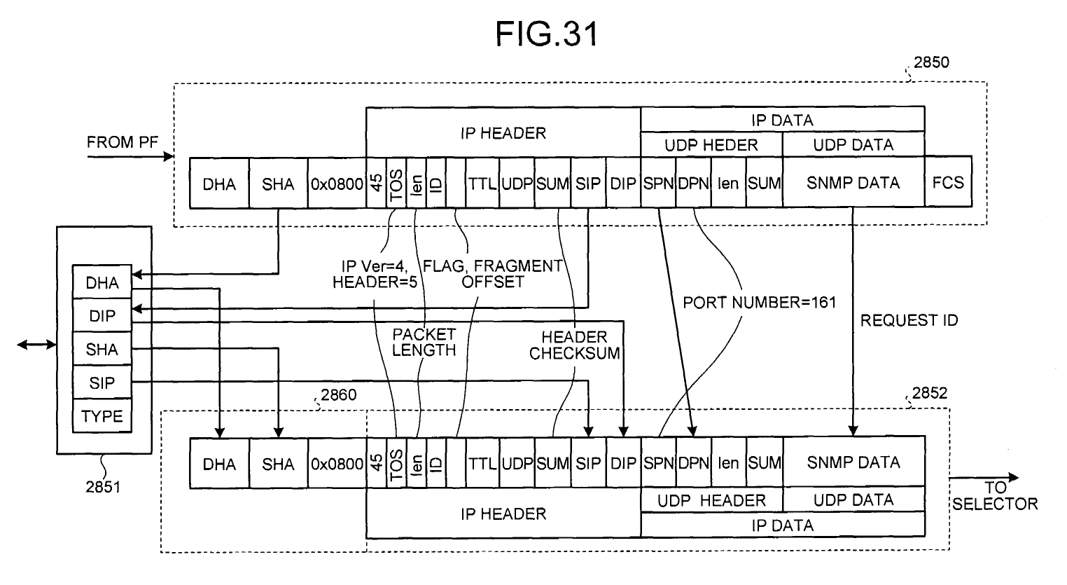

FIG. 31 is a schematic diagram of the IP packet of the MIB response. As shown in FIG. 31, the UDP header generating unit 2857 generates and sets a source port number (SPN), a destination port number (DPN), a segment length (len), and a checksum (SUM) as the UDP header of the MIB response packet. The UDP header generating unit 2857 sets the source port number (SPN) to 161 indicating SNMP. The UDP header generating unit 2857 sets the destination port number (DPN) to the destination port number acquired from the identification data generating unit 2855. The UDP header generating unit 2857 sets the segment length (len) to a length (len+1) of the MIB response packet that is SNMP data. The UDP header generating unit 2857 sets the checksum (SUM) to a 16-bit value of one's complement of the header and the MIB response packet that is the header and the UDP data.

The IP header generating unit 2858 generates the IP header of the IP packet and adds the IP header to the MIB response packet with the UDP header set as above.

The IP header generating unit 2858 preliminarily sets the own station's IP address of MFP/LP in the SIP of the register unit 2851 and sets the own station's hardware address of MFP/LP in the SHA of the register unit 2851. The IP header generating unit 2858 preliminarily sets 0x800 indicating IP in the TYPE of the register unit 2851.

The IP header generating unit 2858 sets the version of the IP head to four and sets the header length to five. The IP header generating unit 2858 sets the type-of-service (TOS) of the IP header to zero. The IP header generating unit 2858 sets the packet length of the IP head to a sum of an IP header length, a UDP header length, and a UDP data length. The IP header generating unit 2858 sets the source IP address (SIP) from the SIP of the register unit and sets the destination IP address (DIP) from the DIP of the register unit.

The IP header generating unit 2858 sets the identifier (ID) of the IP header to an identifier generated by the identification data generating unit 2855. The identifier (ID) is newly generated by the identification data generating unit 2855 each time the IP packet is transmitted. The IP header generating unit 2858 can use, as the identifier (ID), the one transferred from the packet analyzing unit 2850, or can uniquely generate it. In this case, for example, a new identifier (ID) can be an old identifier (ID)+1 with an initial value at the time of power-on being zero.

The IP header generating unit 2858 sets the flag to indicate that the fragmentation is not allowed and that no more fragment exists and the fragment offset is set to zero. The IP header generating unit 2858 sets the time-to-live to 255, which is the maximum value. The IP header generating unit 2858 sets the protocol to 17 indicating UDP. The IP header generating unit 2858 calculates a checksum of the IP header and data for a header checksum (SUM). Options of the header are not generated.

The selector 2859 selects and sends out any one of the ARP reply packet sent out from the ARP reply packet generating unit 2858, the PING reply packet sent out from the PING reply packet generating unit 2854, and the IP packet sent out from the IP packet generating unit 2852 to the Ethernet frame header generating unit 2860. If the MIB request is received and the MIB response is performed, the selector 2859 selects the IP packet sent out from the IP packet generating unit 2852.

The Ethernet frame header generating unit 2860 acquires and adds to the IP packet the destination MAC address from DHA, the source MAC address from SHA, and the type from the TYPE set in the register unit 2851 to generate an Ethernet frame header.

Since the FCS of the Ethernet packet is automatically generated by the MAC 22, the Ethernet frame header generating unit 2860 does not have to generate the FCS.

If the MIB request is received during the energy-saving mode, since the mode is shifted to the controller mode only at the time of the first MIB response, the first MIB response is performed in the controller mode and the output of the PE 2624 is selected from the PM 32 for the selector (SEL) 25. After the first MIB response is completed, the controller mode is shifted to the energy-saving mode.

If the MIB request same as the last time is made during the energy-saving mode, the energy-saving mode is not shifted to the controller mode and the MIB response is performed while maintaining the energy-saving mode. Because the MIB request is the same as the last time, the CPU does not have to set the following object data of the PDU again and uses the MIB response packet generated at the last time.

Data 1: mib-2.25.3.2.1.5.1

Data 2: mib-2.25.3.5.1.1.1

Data 3: mib-2.25.3.5.1.2.1

The data generated by the UDP header generating unit 2857, the IP header generating unit 2858, and the Ethernet frame header generating unit 2860 can also be generated in the same way as the last time.

The generated Ethernet frame packet is transferred through the selector (SEL) 25 to the MAC 22 and is output from the PHY 12.

Since the MIB response is performed in the energy-saving mode to the second or later MIB request, the power consumption can be reduced at the time of the MIB request.

During the energy-saving mode, the output of the PE 2624 is selected from the PM 32 for the selector (SEL) 25. In the PM 32, when the energy-saving mode is shifted to the normal mode or the controller mode, the selector (SEL) selects and inputs the data from the internal bus 34 to the MAC 22 instead of the output of the PE 2624.

According to the third embodiment, the UDP header of the packet, i.e., the SNMP data can be generated without using the CPU and the memory of the printer. Thus, the power consumption can be reduced.

While the printer is explained in the first to third embodiments that has energy-saving mode and controller mode as power saving modes, the present invention can also be applied to other types of information processing apparatuses having other modes than energy-saving mode and controller mode as power-saving mode.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus, comprising:
a controlling unit that controls a plurality of power-saving modes;
a determining unit that determines, upon receipt of a packet via a network while the information processing apparatus is in one of the power-saving modes, whether received packet is a reply request packet that does not require a process to be performed; and
a generating unit that generates, when the received packet is a reply request packet that does not require a process to be performed, a response packet to the received packet while maintaining the information processing apparatus in the one of the power-saving mode; wherein
the determining unit determines, based on content of the received packet, whether the received packet requests return of predetermined information, and
the generating unit generates, when the received packet requests return of predetermined information, the response packet including the predetermined information.

2. The information processing apparatus according to claim 1, further comprising a returning unit that returns the response packet via the network to a source of the reply request packet.

3. The information processing apparatus according to claim 1, wherein the predetermined information is information for identifying the information processing apparatus.

4. The information processing apparatus according to claim 3, wherein the identification information is a sequence number.

5. The information processing apparatus according to claim 1, wherein the predetermined information is Internet control message protocol data.

6. The information processing apparatus according to claim 1, wherein the predetermined information is user datagram protocol data.

7. The information processing apparatus according to claim 6, wherein the user datagram protocol data is simple network management protocol data.

8. The information processing apparatus according to claim 7, wherein the simple network management protocol data is management information block information.

9. The information processing apparatus according to claim 7, wherein
the power-saving modes includes a first mode for supplying power to the controlling unit to operate the information processing apparatus, and a second mode for supplying power to a portion of the controlling unit to operate the information processing apparatus, and
the controlling unit operates the information processing apparatus in the first mode to return a response packet including simple network management protocol data for first time, and operates the information processing apparatus in the second mode to return a response packet including simple network management protocol data from second time.

10. The information processing apparatus according to claim 1, further comprising an application specific integrated circuit that includes the determining unit, the generating unit, and the returning unit.

11. The information processing apparatus according to claim 1, wherein a size of the received packet is equal to or smaller than a predetermined size.

12. An information processing method applied to an information processing apparatus having a plurality of power-saving modes, the information processing method comprising:
controlling the power-saving modes;
determining, upon receipt of a packet via a network while the information processing apparatus is in one of the power-saving modes, whether received packet is a reply request packet that does not require a process to be performed; and
generating, when the received packet is a reply request packet that does not require a process to be performed, a response packet to the received packet while maintaining the information processing apparatus in the one of the power-saving mode; wherein
the determining includes determining, based on content of the received packet, whether the received packet requests return of predetermined information, and
the generating includes generating, when the received packet requests return of predetermined information, the response packet including the predetermined information.

13. A computer program product comprising a computer usable medium having computer readable program codes embodied in the medium that, when executed, causes a computer to execute:
controlling a plurality of power-saving modes;
determining, upon receipt of a packet via a network while the computer is in one of the power-saving modes, whether received packet is a reply request packet that does not require a process to be performed; and
generating, when the received packet is a reply request packet that does not require a process to be performed, a response packet to the received packet while maintaining the computer in the one of the power-saving mode; wherein
the determining includes determining, based on content of the received packet, whether the received packet requests return of predetermined information, and
the generating includes generating, when the received packet requests return of predetermined information, the response packet including the predetermined information.
